(19) United States
(12) Patent Application Publication
(10) Pub. No.: US 2025/0053273 A1
(43) Pub. Date: Feb. 13, 2025

(54) SECURE MESSAGING SYSTEMS AND METHODS

(71) Applicant: UVA IP, LLC, Miami, FL (US)

(72) Inventor: Luis Uva, Miami, FL (US)

(73) Assignee: UVA IP, LLC, Miami, FL (US)

(21) Appl. No.: 18/931,937

(22) Filed: Oct. 30, 2024

Related U.S. Application Data
(63) Continuation-in-part of application No. 18/239,299, filed on Aug. 29, 2023.
Application No. 18/239,299 is a continuation of application No. 17/682,774, filed on Feb. 28, 2022, now Pat. No. 11,797,144.
Application No. 17/682,774 is a continuation-in-part of application No. 15/369,319, filed on Dec. 5, 2016, now abandoned.
(60) Provisional application No. 62/263,311, filed on Dec. 4, 2015.
(60) Provisional application No. 62/268,315, filed on Dec. 16, 2015.

(51) Int. Cl. G06F 3/0481; G06Q 30/0282; H04L 67/141

(52) U.S. Cl. CPC G06F 3/0481; G06Q 30/0282; H04L 67/141

(57) ABSTRACT

Provided herein are exemplary systems and methods for an intelligent secure networked system configured by at least one processor to execute instructions stored in memory, the system including a data retention system and an emotional analytics system, the emotional analytics system performing asynchronous processing to determine if interactions with a user's computing device are such that the user is responding from an emotional state of mind or a meditated state of mind.

### CROSS-REFERENCE TO RELATED APPLICATIONS

This application is a continuation-in-part of Non-provisional application Ser. No. 18/239,299 filed on Aug. 29, 2023, and entitled “SECURE MESSAGING SYSTEMS AND METHODS,” which is a continuation of Non-provisional application Ser. No. 17/682,774 filed on Feb. 28, 2022, now U.S. Pat. No. 11,797,144, issued on Oct. 24, 2023, and entitled “SECURE MESSAGING SYSTEMS AND METHODS,” which is a continuation-in-part of U.S. Non-Provisional patent application Ser. No. 15/369,319 filed on Dec. 5, 2016, and entitled “METHOD FOR SECURING CUSTOMER FEEDBACK”, which claims priority to U.S. provisional patent application Ser. No. 62/263,311 filed on Dec. 4, 2015, and entitled “METHOD AND SYSTEM FOR BRAND OWNER DISTRIBUTOR RELATIONSHIP MANAGEMENT”, and claims priority to U.S. provisional patent application Ser. No. 62/268,315 filed on Dec. 16, 2015, and entitled “METHOD AND SYSTEM FOR BRAND OWNER DISTRIBUTOR RELATIONSHIP MANAGEMENT,” each of which is incorporated herein by reference in its entirety.

### FIELD OF THE INVENTION

The present technology relates generally to secure messaging, and more particularly, but not by limitation, to systems and methods for secure messaging that allow modular subsystem isolation, as well as latency remediation and improved user experiences.

### SUMMARY OF THE DISCLOSURE

In an aspect, a system for gathering qualifying responses may include a user device configured to communicate to a user a prompt, receive a response from the user, determine a response time as a function of the response, and transmit the response and the response time to a computing device, and the computing device configured to receive the response and the response time from the user device, identify a minimum time necessary for a human to read and respond to the prompt; and determine whether the response is a qualifying response as a function of the response time and the minimum time necessary for a human to read and respond to the prompt.

In another aspect, a method of gathering qualifying responses may include, using a user device, communicating to a user a prompt, using the user device, receiving a response from the user, using the user device, determining a response time as a function of the response, using the user device, transmitting the response and the response time to a computing device, using the computing device, receiving the response and the response time from the user device, using the computing device, identifying a minimum time necessary for a human to read and respond to the prompt, and using the computing device, and determining whether the response is a qualifying response as a function of the response time and the minimum time necessary for a human to read and respond to the prompt.

### BRIEF DESCRIPTION OF THE DRAWINGS

The accompanying drawings, where like reference numerals refer to identical or functionally similar elements throughout the separate views, together with the detailed description below, are incorporated in and form part of the specification, and serve to further illustrate embodiments of concepts that include the claimed disclosure and explain various principles and advantages of those embodiments.

The methods and systems disclosed herein have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

FIG. 1 is a schematic diagram of an exemplary computing architecture that includes a system constructed in accordance with the present disclosure.

FIG. 2 shows a flow chart with exemplary steps required to complete a transaction to purchase a product.

FIG. 3 is an exemplary overview of capturing quality feedback, that is, to capture a customer's true emotion, guaranteeing quality feedback.

FIG. 4 illustrates the forming of a habit in the subconscious level and how the CustomerGreen system is able to detect if an event is congruent with it or not.

FIG. 5 illustrates an exemplary scenario where customer feedback is organized by sentiment but quality filters are not applied.

FIG. 6 illustrates an exemplary scenario where customer feedback is organized by sentiment, and quality filters are applied to responses to question 1 (i.e., what is the main emotion related to the experience: happy, neutral or sad).

FIG. 7 illustrates an exemplary scenario where customer feedback is organized by sentiment, and quality filters are applied to responses to question 1 (i.e., what is the main emotion related to the experience: happy, neutral or sad) and to question 2 (i.e., where did the emotion come from, what mattered most: people, product, or process).

FIG. 8 illustrates an exemplary scenario where customer feedback is organized by sentiment, and quality filters are applied to responses to question 1 (i.e., what is the main emotion related to the experience: happy, neutral or sad) and to question 2 (i.e., where did the emotion come from, what mattered most: people, product, or process) and to question 3 (i.e. why did the customer feel that way, which was the trigger).

FIG. 9 summarizes exemplary feedback data quality filters and its use for decision making.

FIG. 10 illustrates an exemplary feedback dashboard, where different feedback quality feedback filters are applied from the control panel. It prioritizes and monetizes all responses.

FIG. 11 is a diagram depicting an exemplary system for gathering qualifying responses.

FIG. 12 is a block diagram of an exemplary embodiment of a machine learning model.

FIG. 13 is a schematic diagram of an exemplary embodiment of a neural network.

FIG. 14 is a schematic diagram of an exemplary embodiment of a neural network node.

FIG. 15 is a diagram depicting an exemplary method of gathering qualifying responses.

### DETAILED DESCRIPTION

Provided herein are exemplary systems and methods for an intelligent secure networked system configured by at least one processor to execute instructions stored in memory, the system including a data retention system and an emotional analytics system, the emotional analytics system performing asynchronous processing to determine if interactions with a user's computing device are such that the user is responding from an emotional state of mind or a meditated state of mind.

A web services layer, according to exemplary embodiments, provides access to the data retention and the emotional analytics system. An application server layer transmits a request to the web services layer for data, the request processed by the batching service transparently to the user, the request processed by the batching service transparently to the user such that the user can continue to use the user-facing application without disruption, the application server layer including a high speed data corridor established between the application server layer and the user's computing device that provides a user-facing application that accesses the data retention and the emotional analytics system through the web services layer, and performs processing based on user interaction with the user-facing application.

In exemplary embodiments, the user-facing application is configured to execute instructions including receiving a first entry from the user's computing device during a first session, transmitting a first digital data element to the interactive graphical user interface of the user's computing device, the first digital data element causing the user's interactive graphical user interface to initiate a second session from the user's computing device while freezing operation of the first session until completion of a final session. Additionally, the first digital data element has three sub elements, sub element 1, sub element 2 and sub element 3 placed horizontally or vertically next to each other. Random variation of an order of presentation of the three sub elements each time the first digital data element is transmitted may be performed.

Upon receiving a second entry from the user's computing device, in various exemplary embodiments, a second digital data element may be transmitted to the interactive graphical user interface of the user's computing device, the second digital data element causing the user's interactive graphical user interface to initiate a third session. The second digital data element may have three sub elements, sub element 1, sub element 2, and sub element 3 placed horizontally or vertically next to each other and random variation of an order of presentation of the three sub elements may occur each time the second digital data element is transmitted. A third entry may be received from the user's computing device and a third digital data element may be transmitted to the interactive graphical user interface of the user's computing device, the third digital data element causing the user's interactive graphical user interface to initiate a final session. The third digital data element may have four sub elements, sub element 1, sub element 2, sub element 3 and sub element 4 placed horizontally or vertically next to each other and the order of presentation of the four sub elements may vary each time the third digital data element is transmitted. A fourth entry may be received from the user's computing device and complete the final session and complete the first session.

Further exemplary embodiments include training a neural network to receive a time required for receiving the second entry, a time required for receiving the third entry and a time required for receiving the fourth entry from 100% or nearly 100% of participating user computing devices that completed the first session and to determine a minimal time for each entry to represent a valid response and to associate each valid response to an associated conclusion. The neural network may be trained to segment a plurality of associated conclusions based on all entries satisfying from a participating user computer device meeting or exceeding the required time. Additionally, the neural network may be trained to segment the plurality of associated conclusions based on a predefined metric.

In various exemplary embodiments, the neural network may be trained to receive a time required for receiving the second entry, a time required for receiving the third entry and a time required for receiving the fourth entry from 100% or nearly 100% of participating user computing devices that completed the first session and to determine a maximum time for each entry to represent a valid response and to associate each valid response to an associated conclusion. The neural network may be trained to segment a plurality of associated conclusions based on all entries satisfying from a participating user computer device meeting or below the required time and training the neural network to segment the plurality of associated conclusions based on a predefined metric.

In some cases, the exemplary systems, methods and/or media herein may be referred to as “Customer Green” or “CustomerGreen” or the like.

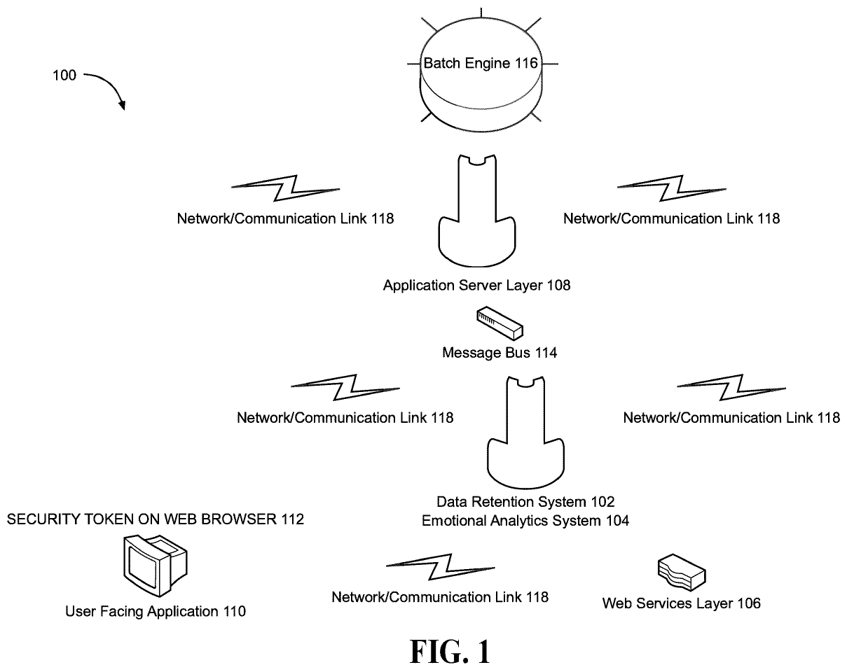

FIG. 1 is a schematic diagram of an example secure messaging system (hereinafter system 100) for practicing aspects of the present disclosure. The system 100 comprises a data retention system 102, an emotional analytics system 104, a web services layer 106, and an application server layer 108 that provides, for example, modeling. Some or all of the activities occur over one or more network/communication links 118.

In some embodiments, the data retention system 102 and emotional analytics system 104 are in secure isolation from a remainder of the secure messaging system 100 through a security protocol or layer. The data retention system 102 can also provide additional services such as logic, data analysis, risk model analysis, security, data privacy controls, data access controls, disaster recovery for data and web services-just to name a few.

The web services layer 106 generally provides access to the data retention system 102. According to some embodiments, the application server layer 108 is configured to provide a user-facing application 110 that accesses the data retention system 102 and emotional analytics system 104 through the web services layer 106. In some embodiments, the user-facing application 110 is secured through use of a security token cached on a web browser 112 that provides the user-facing application 110.

In one or more embodiments, the application server layer 108 performs asynchronous processing based on user interaction with a messaging application that processes data from a user via the user-facing application 110. A messaging application can reside and execute on the application server layer 108. In other embodiments, the messaging application may reside with the emotional analytics system 104. In another embodiment, the messaging application can be a client-side, downloadable application.

The systems of the present disclosure may implement security features that involve the use of multiple security tokens to provide security in the system 100. Security tokens are used between the web services layer 106 and application server layer 108. In some embodiments, security features are not continuous to the web browser 112. Thus, a second security layer or link is established between the web browser 112 and application server layer, 108. In one or more embodiments, a first security token is cached in the application server layer 108 between the web browser 112 and the application server layer 108.

In some embodiments, the system 100 implements an architected message bus 114. In an example usage, a user requests a refresh of their data and user interface through their web browser 112. Rather than performing the refresh, which could involve data intensive and/or compute or operational intensive procedures by the system 100, the message bus 114 allows the request for refresh to be processed asynchronously by a batching process and provides a means for allowing the web browser 112 to continue to display a user-facing application to the user, allowing the user to continue to access data without waiting on the system 100 to complete its refresh.

Also, latency can be remediated at the user-facing application 110 based on the manner with which the user-facing application 110 is created and how the data that is displayed through the user-facing application 110 is stored and updated. For example, data displayed on the user-facing application 110 that changes frequently can cause frequent and unwanted refreshing of the entire user-facing application and interactive graphical user interfaces (“GUIs”). The present disclosure provides a solution to this issue by separating what is displayed on the GUI with the actual underlying data. The underlying data displayed on the GUI of the user-facing application 110 can be updated, as needed, on a segment-by-segment basis (could be defined as a zone of pixels on the display) at a granular level, rather than updating the entire GUI. That is, the GUI that renders the underlying data is programmatically separate from the underlying data cached by the client (e.g., device rendering the GUIs of the user-facing application 110). Due to this separation, when data being displayed on the GUI changes, re-rendering of the data is performed at a granular level, rather than at the page level. This process represents another example solution that remedies latency and improves user experiences with the user-facing application 110.

To facilitate these features, the web browser 112 will listen on the message bus 114 for an acknowledgement or other confirmation that the background processes to update the user account and/or the user-facing application have been completed by the application server layer 108. The user-facing application (or even part thereof) is updated as the system 100 completes its processing. This allows the user-facing application 110 provided through the web browser 112 to be usable, but heavy lifting is being done transparently to the user by the application server layer 108. In sum, these features prevent or reduce latency issues even when an application provided through the web browser 112 is “busy.” For example, a re-balance request is executed transparently by the application server layer 108 and batch engine 116. This type of transparent computing behavior by the system 100 allows for asynchronous operation (initiated from the application server layer 108 or message bus 114).

In some embodiments, a batch engine 116 is included in the system 100 and works in the background to process re-balance requests and coordinate a number of services. An example re-balance request would include an instance where a user selectively makes a data request. The batch engine 116 will transparently orchestrate the necessary operations required by the application server layer 108 in order to obtain data.

According to some embodiments, the batch engine 116 is configured to process requests transparently to a user so that the user can continue to use the user-facing application 110 without disruption. For example, this transparent processing can occur when the application server layer 108 transmits a request to the web services layer 106 for data, and a time required for updating or retrieving the data meets or exceeds a threshold. For example, the threshold might specify that if the request will take more than five seconds to complete, then the batch engine 116 can process the request transparently. The selected threshold can be system configured.

In some embodiments, security of data transmission through the system 100 is improved by use of multiple security tokens. In one embodiment a security token cached on the web browser 112 is different from a security protocol or security token utilized between the application server layer 108 and the web services layer 106.

In some exemplary embodiments, system 100 may include a neural network that is a framework of machine learning algorithms that work together to classify inputs based on a previous training process.

For example, feedback responses as described herein may be transmitted back to the data retention system 102 and/or the emotional analytics system 104. The neural network may be trained to receive a time required for receiving a first entry, a time required for receiving a second entry and a time required for receiving a third entry from 100% or nearly 100% of participating user computing devices that completed the feedback questions. The neural network may determine if each response is a valid response in terms of being from a responder's desired conscious or subconscious state of mind. Further training may include associating the valid responses to an associated conclusion. The neural network may also segment the plurality of associated conclusions based on a predefined metric (e.g., revenue).

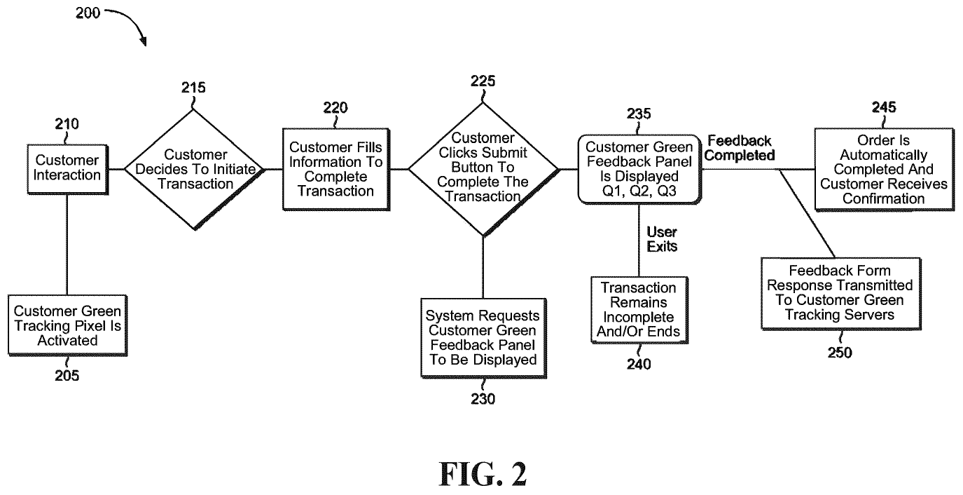

FIG. 2 shows a flow chart with exemplary steps required to complete a transaction to purchase a product.

At step 205, a tracking pixel is activated.

At step 210, customer interaction is initiated.

At step 215, the customer decides to initiate a transaction.

At step 220, the customer provides the information necessary to purchase a product or service. This information generally includes an address for shipment, payment or account information, and other data necessary to make the purchase. The system may optionally, at the conclusion of this step, begin to identify feedback questions to be posed to the customer prior to completion of the transaction.

At step 225, the customer is presented with a mechanism (e.g. a “submit” or “continue” button or similar indicia) to complete the transaction.

At step 230, the system requests a feedback panel to be displayed.

At step 235, the customer is presented a feedback panel with one or more feedback questions which can be presented in a random or specific sequence at the vendor's option. In order to advance the transaction, the customer must respond to the feedback question or questions.

At step 240, the transaction remains incomplete and/or ends. To make it clear to the customer that a response to the feedback question is necessary in order to continue, the submit mechanism (e.g., button) used to advance the transaction is disabled through a routine that continuously checks to determine whether all of the feedback questions have been responded to by the customer. As long as the feedback request is incomplete the submit mechanism remains disabled. If the customer does not complete all of the questions, he or she (according to some embodiments) must initiate the survey all over again. However, if the customer does indeed complete the feedback request, at step 245, the order is automatically completed, and the customer receives a confirmation.

At step 250, feedback form response is transmitted to the tracking server(s) and/or data retention system 102 (FIG. 1) and/or emotional analytics system 104 (FIG. 1).

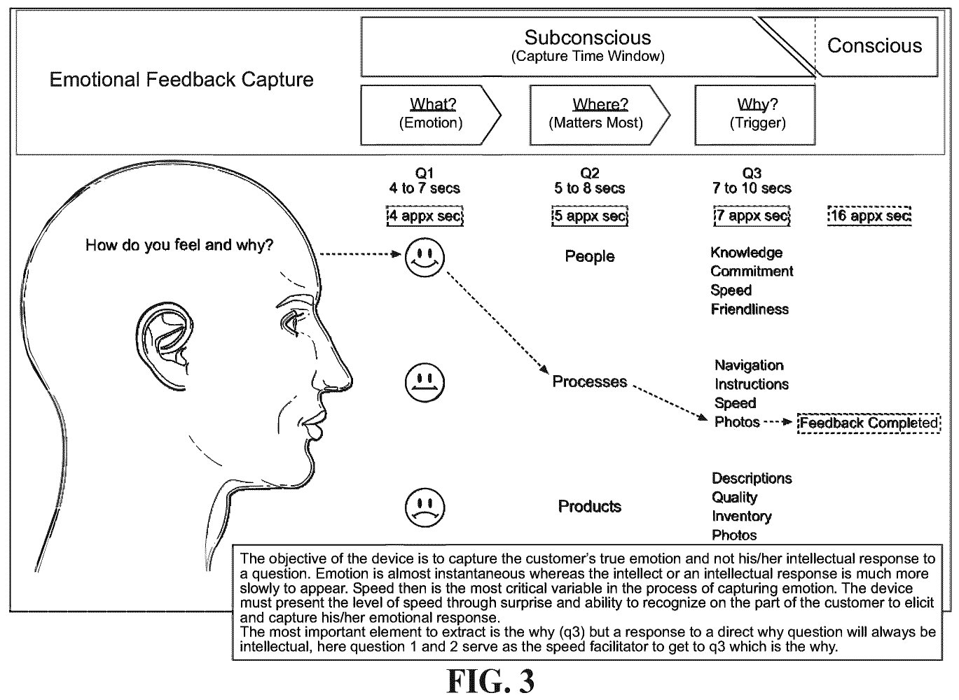

FIG. 3 is an exemplary overview of capturing quality feedback. According to exemplary embodiments, the emotional analytics system performs asynchronous processing to determine if interactions with a user's computing device are such that the user is responding from an emotional state of mind or a meditated state of mind. A batching service, with an application server layer transmitting a request to the web services layer for data, the request processed by the batching service transparently to the user, provides for the user's emotion-based interactions with the system, because the request processed by the batching service transparently to the user is such that the user can continue to use the user-facing application without disruption. The application server layer with a high speed data corridor established between the application server layer and the user's computing device provides a user-facing application that accesses the data retention and the emotional analytics system through the web services layer and performs processing based on user interaction with the user-facing application that executes instructions including receiving a first entry from the user's computing device during a first session (e.g., starting a transaction), transmitting a first digital data element to the interactive graphical user interface of the user's computing device, the first digital data element causing the user's interactive graphical user interface to initiate a second session (e.g., requesting an emotion selection) from the user's computing device while freezing operation of the first session (e.g. the transaction) until completion of a final session (e.g., requesting a trigger).

Additionally, the first digital data element has three sub elements, sub element 1, sub element 2 and sub element 3 (e.g., the emotion faces) placed horizontally or vertically next to each other. These faces can randomly vary in order of presentation each time transmitted. A second entry from the user's computing device causes the user's interactive graphical user interface to initiate a third session (e.g., for the selection of people, process, or products from a user). Receiving a third entry from the user's computing device causes the user's interactive graphical user interface to initiate a final session (e.g., requesting a selection of a trigger from a user). Receiving a fourth entry (e.g., the trigger selection) from the user's computing device completes the final session. Now the first session (e.g., the transaction) is completed.

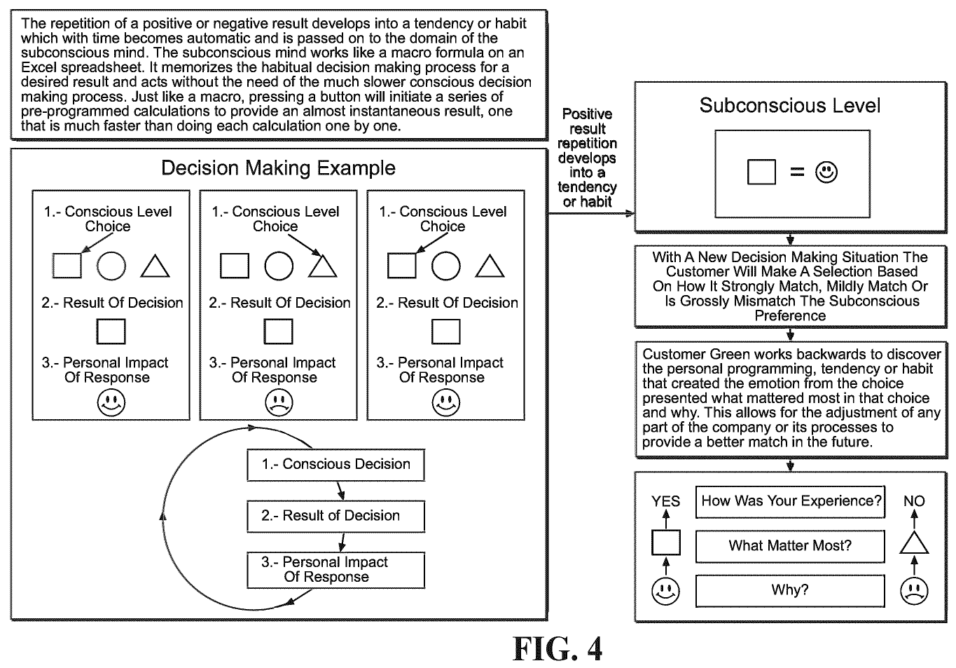

FIG. 4 illustrates the forming of a habit in the subconscious level and how the CustomerGreen system is able to detect if an event is congruent with it or not.

As shown in FIG. 4, at a conscious level, a person presented with a particular environment may make a conscious decision, that may generate an action and/or response. The action and/or response may generate a result. With repetition, this process may generate a subconscious habit. Should a person encounter the particular environment that doesn't match the expected result of the subconscious habit, it may be noted at the person's conscious level. This is detected by the CustomerGreen system, capturing the emotional response of the customer experience.

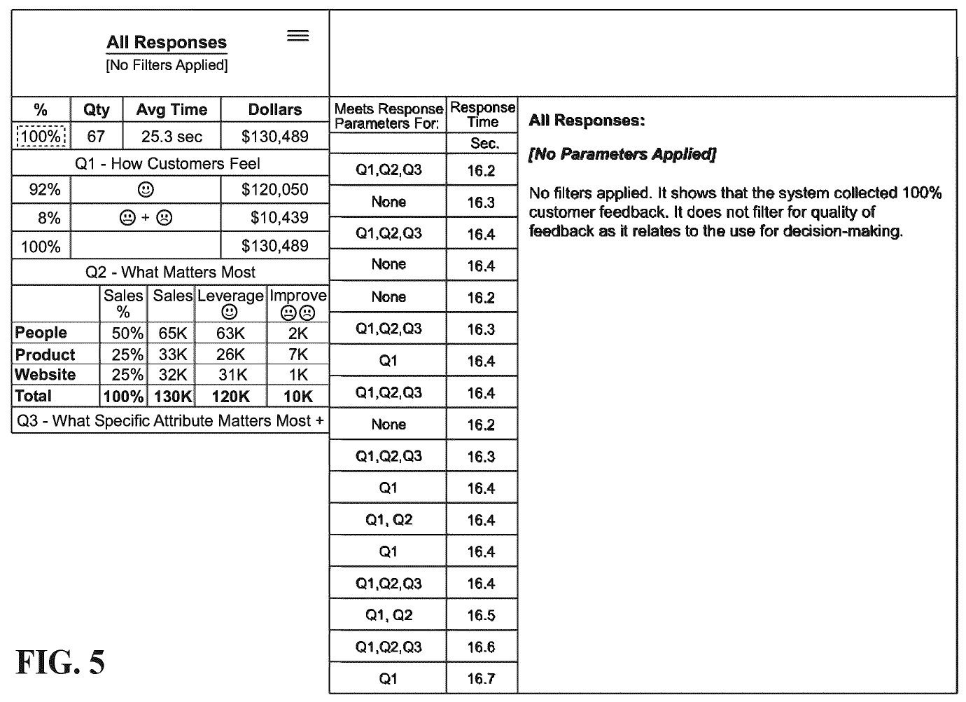

FIG. 5 illustrates a scenario where filtering of customer feedback is not applied. Here, there is no determination of the quality of the customer feedback. In many exemplary embodiments, the customer feedback represents 100% of the customers that have completed a transaction. In other embodiments, the customer feedback represents nearly 100% of the customers that have initiated and/or completed a transaction.

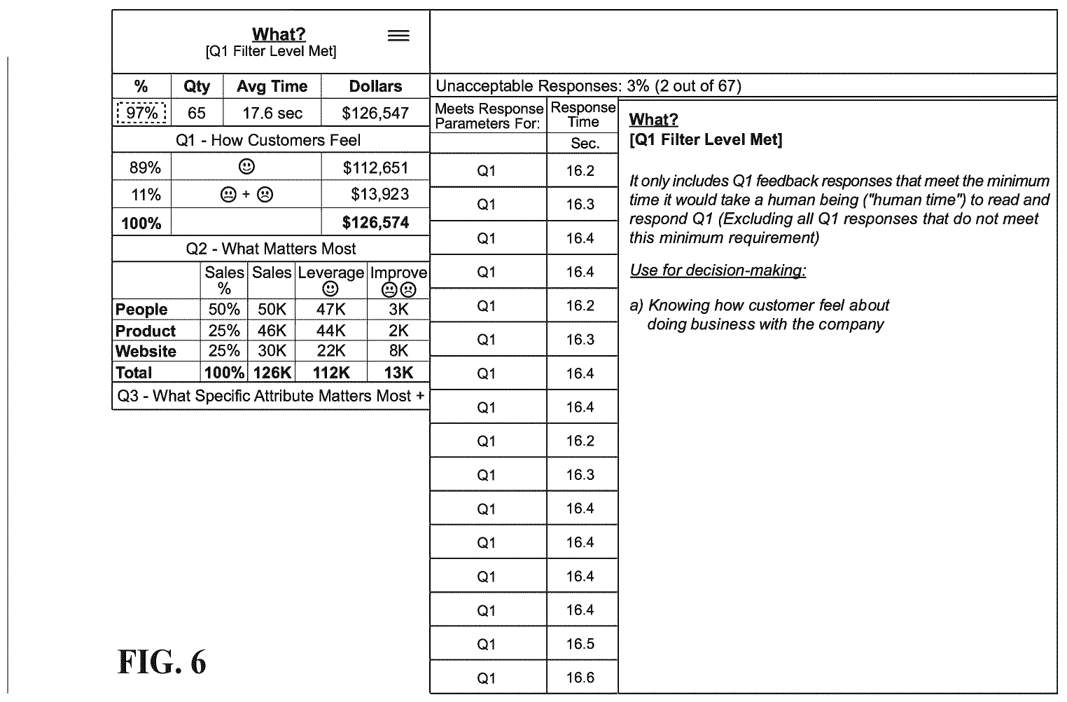

FIG. 6 illustrates a scenario where question 1 (e.g., the emotion faces) responses are filtered. It includes question 1 feedback responses that meet the minimum time required and do not exceed the maximum time required it would take a human to read and respond to question 1 based on an emotional level. Typically, the answer will be a quick recognition because there are not that many variables for consideration and/or because it is spontaneous/emotional because it occurs at a subconscious level. For decision making, one knows how customers feel about doing business with a company.

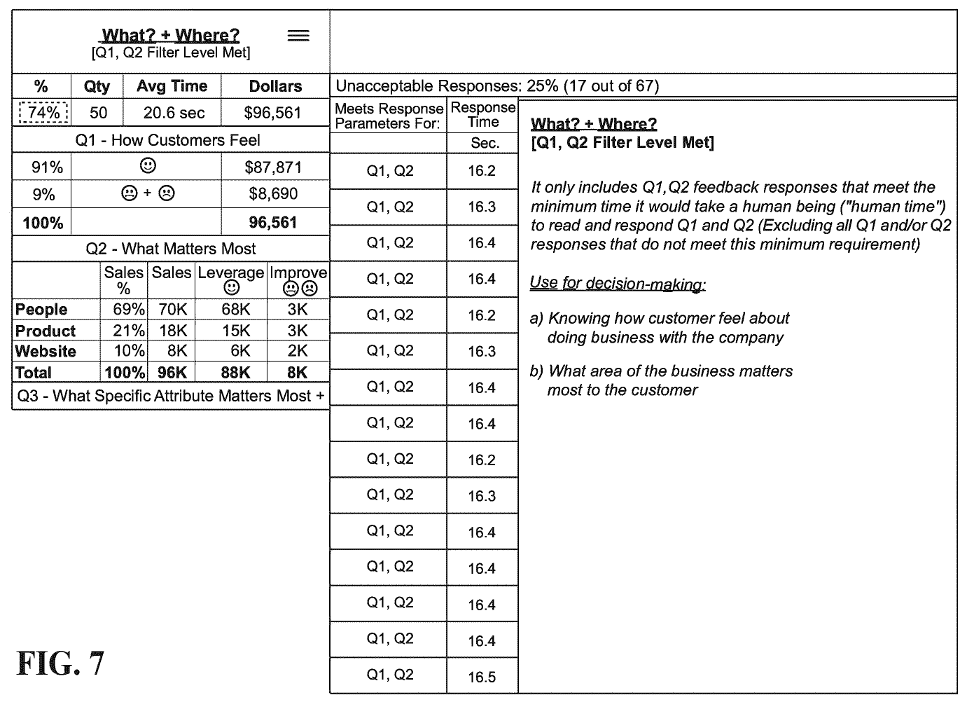

FIG. 7 illustrates a scenario where question 1 (e.g., the emotion faces) and question 2 (e.g., people, process, or products) responses are filtered. It includes question 1 and question 2 feedback responses that meet the minimum time required and do not exceed the maximum time required it would take a human to read and respond to question 1 on an emotional level and question 2 based on more of a subconscious level. Please note: both answers to question 1 and 2 occur at a subconscious level. Question 2 typically involves what a customer has direct experience with, versus what may happen behind the scenes e.g., in the accounting department. For decision making, one knows how customers feel about doing business with a company and what area of the business matters most to the customer.

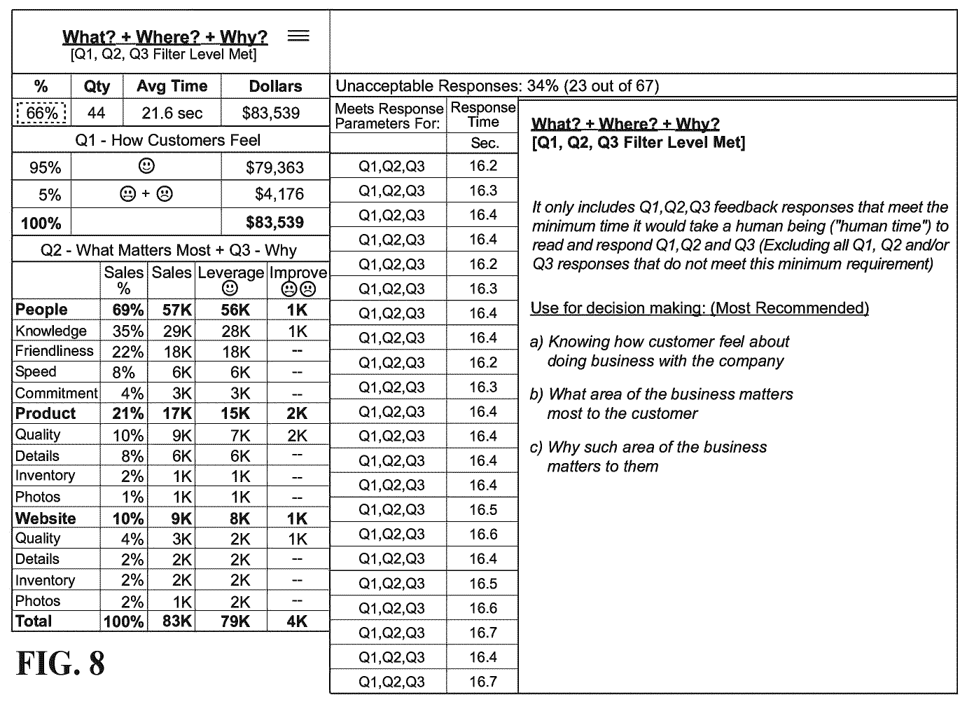

FIG. 8 illustrates a scenario where question 1 (e.g., the emotion faces), question 2 (e.g., people, process, or products) and question 3 (e.g., triggers) responses are filtered. It includes question 1, question 2 and question 3 feedback responses that meet the minimum time required and do not exceed the maximum time required it would take a human to read and respond to question 1 on an emotional level, question 2 on more of a subconscious level, and question 3 based on more of a conscious level. Please note: both answers to question 1 and 2 occur at a subconscious level. Additionally, response times that exceed the maximum suggest the response is based on a conscious level and response times that fall below the minimum suggest the response was from someone aimlessly clicking through the possible response choices.

In many exemplary embodiments, minimum and maximum response times are determined for each question by establishing a bell curve for the entire population of responses for each question and selecting a certain percentage of responses around both sides of the middle of the bell curve for each question. Additionally, this can be performed for new and returning customers, as well as customers returning products. In the case of customers returning products, similar to the case of completing a purchase transaction, the customer will have to complete the questionnaire prior to completing the product return. As the number of responses increases and/or the certain percentages may change, the minimum and maximum response times may be recalculated.

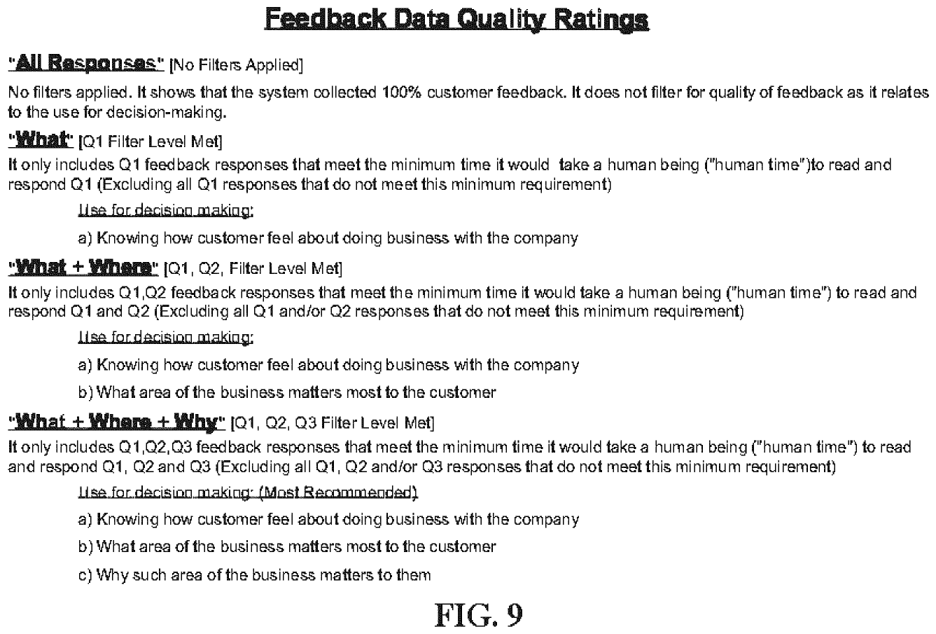

FIG. 9 summarizes exemplary feedback data quality filters and its use for decision making.

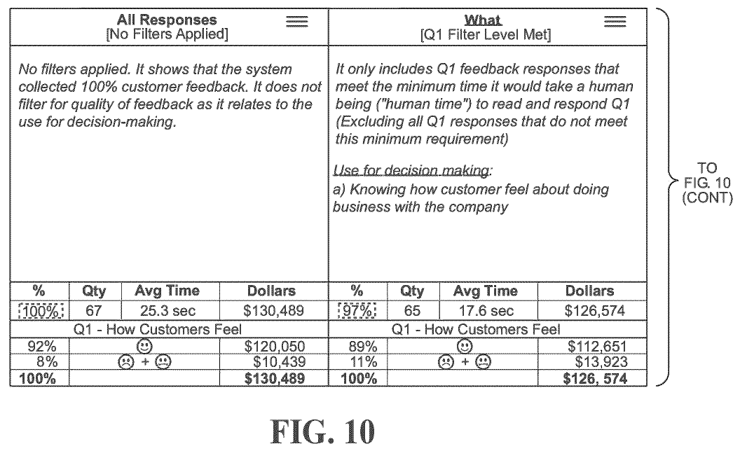

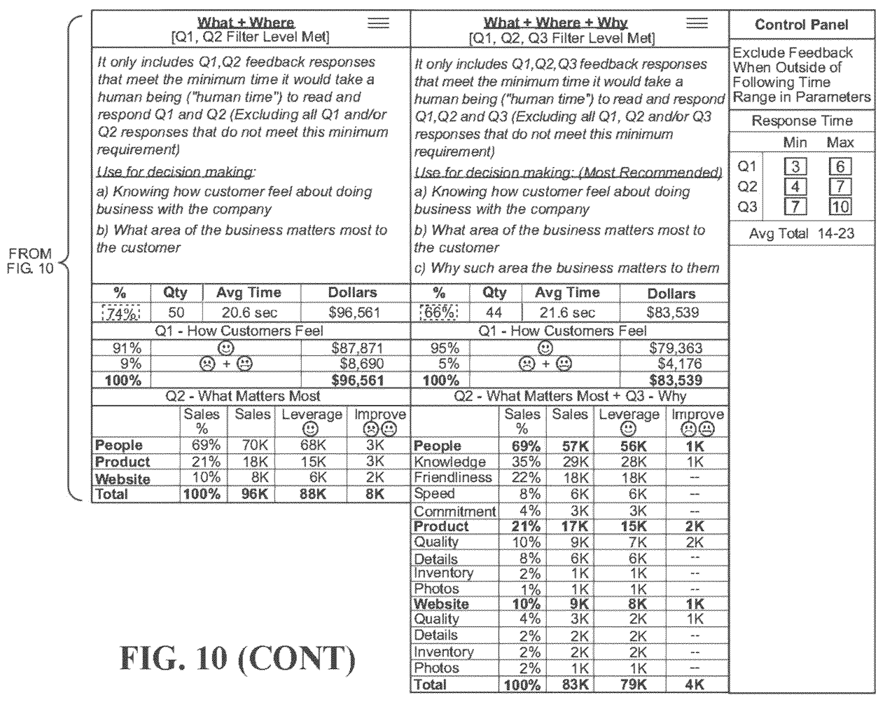

FIG. 10 prioritizes and monetizes feedback data quality ratings. As shown in FIG. 10, for each question, and for the total of qualifying responses (e.g., meeting the time limitations) as well as the associated total dollars, a determination may be made for areas to prioritize. For example, in FIG. 10, for customer responses satisfying the criteria for questions 1 and 2, 91% of the happy customers as determined by question 1 indicated that people matter most, as determined by question 2, as shown by 69% of the 91% of happy customers and their approximately $70,000 of sales.

According to various exemplary embodiments, a neural network may be trained to receive a time required for receiving the second entry, a time required for receiving the third entry and a time required for receiving the fourth entry from 100% or nearly 100% of participating user computing devices that completed the first session and to determine a minimal and a maximum time for each entry to represent a valid response and to associate each valid response to an associated conclusion. A neural network is a framework of machine learning algorithms that work together to classify inputs based on a previous training process.

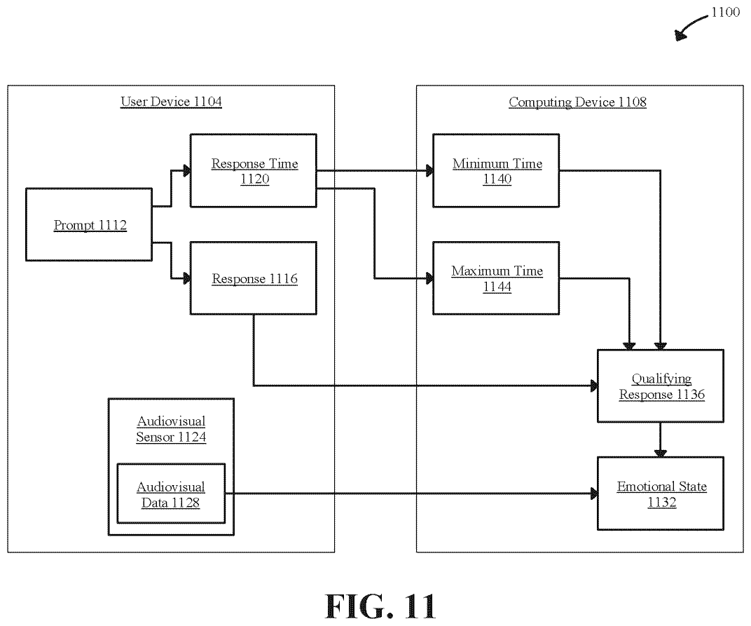

Referring now to FIG. 11, system 1100 may include user device 1104. In some embodiments, user device 1104 may include a user interface. A user interface may be a component of user device 1104. User device 1104 may include, in non-limiting examples, a smartphone, smartwatch, laptop computer, desktop computer, virtual reality device, or tablet. As used herein, a “user interface” is a mechanism by which a user may input information into a computing device, a mechanism by which a computing device may output information to a user, or both. User interface may include an input interface and/or an output interface. An input interface may include one or more mechanisms for a computing device to receive data from a user such as, in non-limiting examples, a mouse, keyboard, button, scroll wheel, camera, microphone, switch, lever, touchscreen, trackpad, joystick, and controller. An output interface may include one or more mechanisms for a computing device to output data to a user such as, in non-limiting examples, a screen, speaker, and haptic feedback system. An output interface may be used to display one or more elements of data described herein. As used herein, a device “displays” a datum if the device outputs the datum in a format suitable for communication to a user. For example, a device may display a datum by outputting text or an image on a screen or outputting a sound using a speaker.

Still referring to FIG. 11, system 1100 may include computing device 1108. Computing device 1108 may include any computing device as described in this disclosure, including without limitation a microcontroller, microprocessor, digital signal processor (DSP) and/or system on a chip (SoC) as described in this disclosure. Computing device may include, be included in, and/or communicate with a user device such as a mobile telephone or smartphone. Computing device may include a single computing device operating independently, or may include two or more computing device operating in concert, in parallel, sequentially or the like; two or more computing devices may be included together in a single computing device or in two or more computing devices. Computing device may interface or communicate with one or more additional devices as described below in further detail via a network interface device. Network interface device may be utilized for connecting computing device to one or more of a variety of networks, and one or more devices. Examples of a network interface device include, but are not limited to, a network interface card (e.g., a mobile network interface card, a LAN card), a modem, and any combination thereof. Examples of a network include, but are not limited to, a wide area network (e.g., the Internet, an enterprise network), a local area network (e.g., a network associated with an office, a building, a campus or other relatively small geographic space), a telephone network, a data network associated with a telephone/voice provider (e.g., a mobile communications provider data and/or voice network), a direct connection between two computing devices, and any combinations thereof. A network may employ a wired and/or a wireless mode of communication. In general, any network topology may be used. Information (e.g., data, software etc.) may be communicated to and/or from a computer and/or a computing device.

Still referring to FIG. 11, computing device 1108 may include but is not limited to, for example, a computing device or cluster of computing devices in a first location and a second computing device or cluster of computing devices in a second location. Computing device 1108 may include one or more computing devices dedicated to data storage, security, distribution of traffic for load balancing, and the like. Computing device 1108 may distribute one or more computing tasks as described below across a plurality of computing devices of computing device, which may operate in parallel, in series, redundantly, or in any other manner used for distribution of tasks or memory between computing devices. Computing device 1108 may be implemented, as a non-limiting example, using a “shared nothing” architecture.

Still referring to FIG. 11, computing device 1108 may be designed and/or configured to perform any method, method step, or sequence of method steps in any embodiment described in this disclosure, in any order and with any degree of repetition. For instance, computing device 1108 may be configured to perform a single step or sequence repeatedly until a desired or commanded outcome is achieved; repetition of a step or a sequence of steps may be performed iteratively and/or recursively using outputs of previous repetitions as inputs to subsequent repetitions, aggregating inputs and/or outputs of repetitions to produce an aggregate result, reduction or decrement of one or more variables such as global variables, and/or division of a larger processing task into a set of iteratively addressed smaller processing tasks. Computing device 1108 may perform any step or sequence of steps as described in this disclosure in parallel, such as simultaneously and/or substantially simultaneously performing a step two or more times using two or more parallel threads, processor cores, or the like; division of tasks between parallel threads and/or processes may be performed according to any protocol suitable for division of tasks between iterations. Persons skilled in the art, upon reviewing the entirety of this disclosure, will be aware of various ways in which steps, sequences of steps, processing tasks, and/or data may be subdivided, shared, or otherwise dealt with using iteration, recursion, and/or parallel processing.

Still referring to FIG. 11, as used in this disclosure, “communicatively connected” means connected by way of a connection, attachment or linkage between two or more relata which allows for reception and/or transmittance of information therebetween. For example, and without limitation, this connection may be wired or wireless, direct or indirect, and between two or more components, circuits, devices, systems, and the like, which allows for reception and/or transmittance of data and/or signal(s) therebetween. Data and/or signals therebetween may include, without limitation, electrical, electromagnetic, magnetic, video, audio, radio and microwave data and/or signals, combinations thereof, and the like, among others. A communicative connection may be achieved, for example and without limitation, through wired or wireless electronic, digital or analog, communication, either directly or by way of one or more intervening devices or components. Further, communicative connection may include electrically coupling or connecting at least an output of one device, component, or circuit to at least an input of another device, component, or circuit. For example, and without limitation, via a bus or other facility for intercommunication between elements of a computing device. Communicative connecting may also include indirect connections via, for example and without limitation, wireless connection, radio communication, low power wide area network, optical communication, magnetic, capacitive, or optical coupling, and the like. In some instances, the terminology “communicatively coupled” may be used in place of communicatively connected in this disclosure.

Still referring to FIG. 11, in some embodiments, user device 1104 may communicate to a user prompt 1112, receive a response 1116 from a user, and/or determine a response time 1120. In some embodiments, user device 1104 may transmit response 1116 and response time 1120 to computing device 1108. As used herein, a “prompt” is a datum displayed to a user which encourages the user to respond to the datum. In a non-limiting example, a prompt may include a question posed to a user. As used herein, a “response” is a datum input by a user which is responsive to a prompt. In a non-limiting example, a response may include an answer to a question posed to a user. As used herein, a “response time” is a duration of time between a prompt being displayed to a user and the user inputting a response. User device 1104 and/or computing device 1108 may calculate response time 1120 as a function of prompt 1112 and/or response 1116. For example, user device 1104 and/or computing device 1108 may calculate response time 1120 based on a difference between a time at which prompt 1112 is displayed to a user and a time at which response 1116 is input into user device 1104.

Still referring to FIG. 11, in some embodiments, user device 1104 and/or computing device 1108 may, using audiovisual sensor 1124, collect audiovisual data 1128. As used herein, “audiovisual data” is audio data, visual data, or both. Audiovisual data may include, in non-limiting examples, images, video files, and audio files which are collected by user device 1104. As used herein, an “audiovisual sensor” is a component of a user device which is configured to collect audiovisual data. In some embodiments, user device 1104 may include audiovisual sensor 1124. In some embodiments, user device 1104 may be configured to collect audiovisual data 1128. In some embodiments, user device 1104 may be configured to transmit audiovisual data 1128 to computing device 1108. In some embodiments, computing device 1108 may be configured to receive audiovisual data 1128 from user device 1104. In some embodiments, computing device 1108 may be configured to determine an emotional state 1132 of a user as a function of audiovisual data 1128. As used herein, an “emotional state” of a user is a datum describing an estimate of an emotion experienced by a user at a particular point in time, a datum describing an estimate of a degree to which an action of a user is driven by emotion, or both. An emotional state 1132 of a user may include, in a non-limiting example, a degree to which response 1116 is driven by emotion. In another non-limiting example, an emotional state 1132 may include a degree to which a user feels happy as the user inputs into user device 1104 prompt 1112. In some embodiments, an emotional state 1132 of a user may be determined based on audiovisual data 1128 and/or qualifying response 1136.

Still referring to FIG. 11, an emotional state 1132 of a user may be determined based on audiovisual data 1128 and/or qualifying response 1136. In some embodiments, prompt 1112 may be directed to an emotion of a user. For example, prompt 1112 may be directed to a current degree to which a user feels happy. In some embodiments, an emotional state of a user may be determined as a function of response 1116 and a determination as to whether response 1116 is a qualifying response 1136. As used herein, a “qualifying response” is an emotional or intellectual response. An emotional response may include, as a non-limiting example, an intuitive or gut-level response. An intellectual response may include, as a non-limiting example, a reasoned or deliberate response. For example, an emotional response may be a fast response that represents a gut reaction of a user. For example, an intellectual response may be slower, meaning that the user had more time to consider the response. Computing device 1108 and/or user device 1104 may determine whether a response 1116 is a qualifying response 1136 as described below.

Still referring to FIG. 11, in some embodiments, audiovisual data 1128 may include audio data. For example, audiovisual data 1128 may include audio recorded using audiovisual sensor 1124 including a microphone. In some embodiments, a process for determining an emotional state 1132 of a user may include transcribing such audio data using an automatic speech recognition program. Such transcription may then be used in a process of analyzing text, such as a large language model. In some embodiments, automatic speech recognition may require training (i.e., enrollment). In some cases, training an automatic speech recognition model may require an individual speaker to read text or isolated vocabulary. In some cases, audio training data may include an audio component having audible verbal content, the contents of which are known a priori by a computing device. Computing device may then train an automatic speech recognition model according to training data which includes audible verbal content correlated to known content. In this way, computing device may analyze a person's specific voice and train an automatic speech recognition model to the person's speech, resulting in increased accuracy. Alternatively, or additionally, in some cases, computing device may include an automatic speech recognition model that is speaker independent. As used in this disclosure, a “speaker independent” automatic speech recognition process is an automatic speech recognition process that does not require training for each individual speaker. Conversely, as used in this disclosure, automatic speech recognition processes that employ individual speaker specific training are “speaker dependent.”

Still referring to FIG. 11, in some embodiments, an automatic speech recognition process may perform voice recognition or speaker identification. As used in this disclosure, “voice recognition” is a process of identifying a speaker, from audio content, rather than what the speaker is saying. In some cases, computing device may first recognize a speaker of verbal audio content and then automatically recognize speech of the speaker, for example by way of a speaker dependent automatic speech recognition model or process. In some embodiments, an automatic speech recognition process can be used to authenticate or verify an identity of a speaker. In some cases, a speaker may or may not include subject. For example, subject may speak within audio data, but others may speak as well.

Still referring to FIG. 11, in some embodiments, an automatic speech recognition process may include one or all of acoustic modeling, language modeling, and statistically based speech recognition algorithms. In some cases, an automatic speech recognition process may employ hidden Markov models (HMMs). As discussed in greater detail below, language modeling such as that employed in natural language processing applications like document classification or statistical machine translation, may also be employed by an automatic speech recognition process.

Still referring to FIG. 11, an exemplary algorithm employed in automatic speech recognition may include or even be based upon hidden Markov models. Hidden Markov models (HMMs) may include statistical models that output a sequence of symbols or quantities. HMMs can be used in speech recognition because a speech signal can be viewed as a piecewise stationary signal or a short-time stationary signal. For example, over a short time scale (e.g., 10 milliseconds), speech can be approximated as a stationary process. Speech (i.e., audible verbal content) can be understood as a Markov model for many stochastic purposes.

Still referring to FIG. 11, in some embodiments HMMs can be trained automatically and may be relatively simple and computationally feasible to use. In an exemplary automatic speech recognition process, a hidden Markov model may output a sequence of n-dimensional real-valued vectors (with n being a small integer, such as 10), at a rate of about one vector every 10 milliseconds. Vectors may consist of cepstral coefficients. A cepstral coefficient requires using a spectral domain. Cepstral coefficients may be obtained by taking a Fourier transform of a short time window of speech yielding a spectrum, decorrelating the spectrum using a cosine transform, and taking first (i.e., most significant) coefficients. In some cases, an HMM may have in each state a statistical distribution that is a mixture of diagonal covariance Gaussians, yielding a likelihood for each observed vector. In some cases, each word, or phoneme, may have a different output distribution; an HMM for a sequence of words or phonemes may be made by concatenating an HMMs for separate words and phonemes.

Still referring to FIG. 11, in some embodiments, an automatic speech recognition process may use various combinations of a number of techniques in order to improve results. In some cases, a large-vocabulary automatic speech recognition process may include context dependency for phonemes. For example, in some cases, phonemes with different left and right context may have different realizations as HMM states. In some cases, an automatic speech recognition process may use cepstral normalization to normalize for different speakers and recording conditions. In some cases, an automatic speech recognition process may use vocal tract length normalization (VTLN) for male-female normalization and maximum likelihood linear regression (MLLR) for more general speaker adaptation. In some cases, an automatic speech recognition process may determine so-called delta and delta-delta coefficients to capture speech dynamics and might use heteroscedastic linear discriminant analysis (HLDA). In some cases, an automatic speech recognition process may use splicing and a linear discriminate analysis (LDA)-based projection, which may include heteroscedastic linear discriminant analysis or a global semi-tied covariance transform (also known as maximum likelihood linear transform [MLLT]). In some cases, an automatic speech recognition process may use discriminative training techniques, which may dispense with a purely statistical approach to HMM parameter estimation and instead optimize some classification-related measure of training data; examples may include maximum mutual information (MMI), minimum classification error (MCE), and minimum phone error (MPE).

Still referring to FIG. 11, in some embodiments, an automatic speech recognition process may be said to decode speech (i.e., audible verbal content). Decoding of speech may occur when an automatic speech recognition system is presented with a new utterance and must compute a most likely sentence. In some cases, speech decoding may include a Viterbi algorithm. A Viterbi algorithm may include a dynamic programming algorithm for obtaining a maximum a posteriori probability estimate of a most likely sequence of hidden states (i.e., Viterbi path) that results in a sequence of observed events. Viterbi algorithms may be employed in context of Markov information sources and hidden Markov models. A Viterbi algorithm may be used to find a best path, for example using a dynamically created combination hidden Markov model, having both acoustic and language model information, using a statically created combination hidden Markov model (e.g., finite state transducer [FST] approach).

Still referring to FIG. 11, in some embodiments, speech (i.e., audible verbal content) decoding may include considering a set of good candidates and not only a best candidate, when presented with a new utterance. In some cases, a better scoring function (i.e., re-scoring) may be used to rate each of a set of good candidates, allowing selection of a best candidate according to this refined score. In some cases, a set of candidates can be kept either as a list (i.e., N-best list approach) or as a subset of models (i.e., a lattice). In some cases, re-scoring may be performed by optimizing Bayes risk (or an approximation thereof). In some cases, re-scoring may include optimizing for sentence (including keywords) that minimizes an expectancy of a given loss function with regards to all possible transcriptions. For example, re-scoring may allow selection of a sentence that minimizes an average distance to other possible sentences weighted by their estimated probability. In some cases, an employed loss function may include Levenshtein distance, although different distance calculations may be performed, for instance for specific tasks. In some cases, a set of candidates may be pruned to maintain tractability.

Still referring to FIG. 11, in some embodiments, an automatic speech recognition process may employ dynamic time warping (DTW)-based approaches. Dynamic time warping may include algorithms for measuring similarity between two sequences, which may vary in time or speed. For instance, similarities in walking patterns would be detected, even if in one video the person was walking slowly and if in another he or she were walking more quickly, or even if there were accelerations and deceleration during the course of one observation. DTW has been applied to video, audio, and graphics-indeed, any data that can be turned into a linear representation can be analyzed with DTW. In some cases, DTW may be used by an automatic speech recognition process to cope with different speaking (i.e., audible verbal content) speeds. In some cases, DTW may allow computing device to find an optimal match between two given sequences (e.g., time series) with certain restrictions. That is, in some cases, sequences can be “warped” non-linearly to match each other. In some cases, a DTW-based sequence alignment method may be used in context of hidden Markov models.

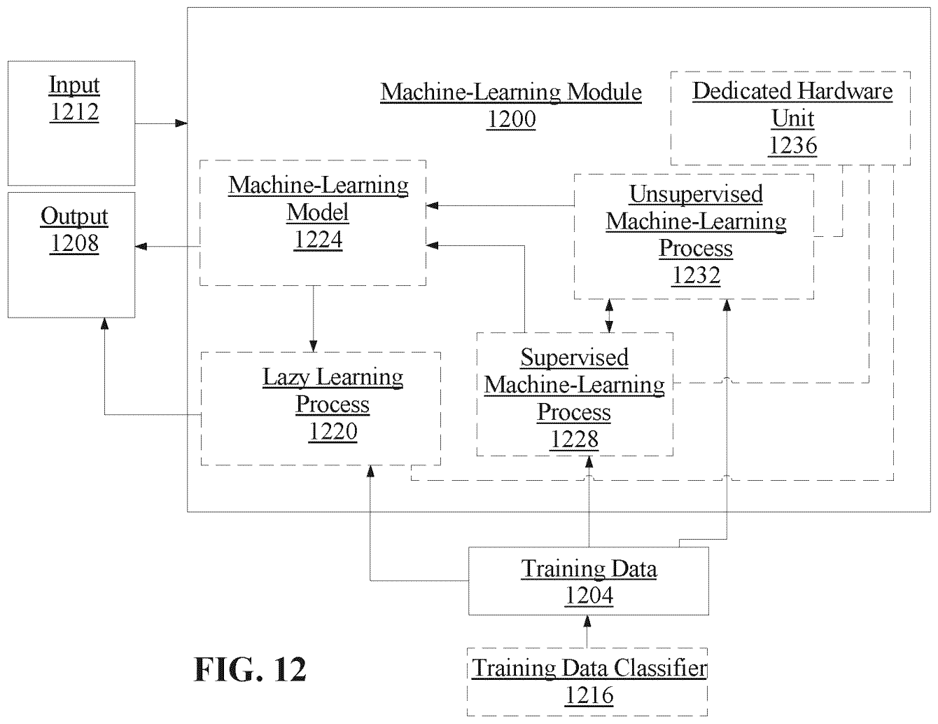

Still referring to FIG. 11, in some embodiments, an automatic speech recognition process may include a neural network. Neural network may include any neural network, for example those disclosed with reference to FIGS. 12-14. In some cases, neural networks may be used for automatic speech recognition, including phoneme classification, phoneme classification through multi-objective evolutionary algorithms, isolated word recognition, audiovisual speech recognition, audiovisual speaker recognition and speaker adaptation. In some cases, neural networks employed in automatic speech recognition may make fewer explicit assumptions about feature statistical properties than HMMs and therefore may have several qualities making them attractive recognition models for speech recognition. When used to estimate the probabilities of a speech feature segment, neural networks may allow discriminative training in a natural and efficient manner. In some cases, neural networks may be used to effectively classify audible verbal content over short-time interval, for instance such as individual phonemes and isolated words. In some embodiments, a neural network may be employed by automatic speech recognition processes for pre-processing, feature transformation and/or dimensionality reduction, for example prior to HMM-based recognition. In some embodiments, long short-term memory (LSTM) and related recurrent neural networks (RNNs) and Time Delay Neural Networks (TDNN's) may be used for automatic speech recognition, for example over longer time intervals for continuous speech recognition.

Still referring to FIG. 11, in some embodiments, determining emotional state 1132 may include processing a transcript using a sentiment analysis process. Sentiment analysis may include a process of analyzing text to determine a degree of positivity of the text. In some embodiments, sentiment analysis may include one or more preprocessing steps, such as tokenization of elements of natural language, conversion of words into their root form, and/or application of a stop word removal filter. In some embodiments, a sentiment analysis process may use a rule based system which determines sentiment based on keywords within input text. In some embodiments, a sentiment analysis machine learning model may be used. In some embodiments, such a machine learning model may be trained using a supervised learning algorithm, based on training data including example text, associated with example sentiment labels.

Still referring to FIG. 11, in some embodiments, audiovisual data 1128 may include natural language data. In some embodiments, such natural language data may include data processed using an automatic speech recognition system as described above. In some embodiments, determining emotional state 1132 of a user may include interpreting natural language data using a large language model (LLM). A “large language model,” as used herein, is a deep learning data structure that can recognize, summarize, translate, predict and/or generate text and other content based on knowledge gained from massive datasets. Large language models may be trained on large sets of data. Training sets may be drawn from diverse sets of data such as, as non-limiting examples, novels, blog posts, articles, emails, unstructured data, audiovisual data, and the like. In some embodiments, training sets may include a variety of subject matters, such as, as nonlimiting examples, medical report documents, electronic health records, entity documents, business documents, inventory documentation, emails, user communications, advertising documents, newspaper articles, and the like. In some embodiments, training sets of an LLM may include information from one or more public or private databases. As a non-limiting example, training sets may include databases associated with an entity. In some embodiments, training sets may include portions of documents associated with audiovisual data correlated to examples of outputs. In an embodiment, an LLM may include one or more architectures based on capability requirements of an LLM. Exemplary architectures may include, without limitation, GPT (Generative Pretrained Transformer), BERT (Bidirectional Encoder Representations from Transformers), T5 (Text-To-Text Transfer Transformer), and the like. Architecture choice may depend on a needed capability such generative, contextual, or other specific capabilities.

Still referring to FIG. 11, in some embodiments, an LLM may be generally trained. As used in this disclosure, a “generally trained” LLM is an LLM that is trained on a general training set comprising a variety of subject matters, data sets, and fields. In some embodiments, an LLM may be initially generally trained. Additionally, or alternatively, an LLM may be specifically trained. As used in this disclosure, a “specifically trained” LLM is an LLM that is trained on a specific training set, wherein the specific training set includes data including specific correlations for the LLM to learn. As a non-limiting example, an LLM may be generally trained on a general training set, then specifically trained on a specific training set. In an embodiment, specific training of an LLM may be performed using a supervised machine learning process. In some embodiments, generally training an LLM may be performed using an unsupervised machine learning process. As a non-limiting example, specific training set may include information from a database. As a non-limiting example, specific training set may include text related to the users such as user specific data for audiovisual data correlated to examples of outputs. In an embodiment, training one or more machine learning models may include setting the parameters of the one or more models (weights and biases) either randomly or using a pretrained model. Generally training one or more machine learning models on a large corpus of text data can provide a starting point for fine-tuning on a specific task. A model such as an LLM may learn by adjusting its parameters during the training process to minimize a defined loss function, which measures the difference between predicted outputs and ground truth. Once a model has been generally trained, the model may then be specifically trained to fine-tune the pretrained model on task-specific data to adapt it to the target task. Fine-tuning may involve training a model with task-specific training data, adjusting the model's weights to optimize performance for the particular task. In some cases, this may include optimizing the model's performance by fine-tuning hyperparameters such as learning rate, batch size, and regularization. Hyperparameter tuning may help in achieving the best performance and convergence during training. In an embodiment, fine-tuning a pretrained model such as an LLM may include fine-tuning the pretrained model using Low-Rank Adaptation (LoRA). As used in this disclosure, “Low-Rank Adaptation” is a training technique for large language models that modifies a subset of parameters in the model. Low-Rank Adaptation may be configured to make the training process more computationally efficient by avoiding a need to train an entire model from scratch. In an exemplary embodiment, a subset of parameters that are updated may include parameters that are associated with a specific task or domain.

Still referring to FIG. 11, in some embodiments an LLM may include and/or be produced using Generative Pretrained Transformer (GPT), GPT-2, GPT-3, GPT-4, and the like. GPT, GPT-2, GPT-3, GPT-3.5, and GPT-4 are products of Open AI Inc., of San Francisco, CA. An LLM may include a text prediction based algorithm configured to receive an article and apply a probability distribution to the words already typed in a sentence to work out the most likely word to come next in augmented articles. For example, if some words that have already been typed are “Nice to meet”, then it may be highly likely that the word “you” will come next. An LLM may output such predictions by ranking words by likelihood or a prompt parameter. For the example given above, an LLM may score “you” as the most likely, “your” as the next most likely, “his” or “her” next, and the like. An LLM may include an encoder component and a decoder component.

Still referring to FIG. 11, an LLM may include a transformer architecture. In some embodiments, encoder component of an LLM may include transformer architecture. A “transformer architecture,” for the purposes of this disclosure is a neural network architecture that uses self-attention and positional encoding. Transformer architecture may be designed to process sequential input data, such as natural language, with applications towards tasks such as translation and text summarization. Transformer architecture may process the entire input all at once. “Positional encoding,” for the purposes of this disclosure, refers to a data processing technique that encodes the location or position of an entity in a sequence. In some embodiments, each position in the sequence may be assigned a unique representation. In some embodiments, positional encoding may include mapping each position in the sequence to a position vector. In some embodiments, trigonometric functions, such as sine and cosine, may be used to determine the values in the position vector. In some embodiments, position vectors for a plurality of positions in a sequence may be assembled into a position matrix, wherein each row of position matrix may represent a position in the sequence.

Still referring to FIG. 11, an LLM and/or transformer architecture may include an attention mechanism. An “attention mechanism,” as used herein, is a part of a neural architecture that enables a system to dynamically quantify the relevant features of the input data. In the case of natural language processing, input data may be a sequence of textual elements. It may be applied directly to the raw input or to its higher-level representation.

Still referring to FIG. 11, attention mechanism may represent an improvement over a limitation of an encoder-decoder model. An encoder-decider model encodes an input sequence to one fixed length vector from which the output is decoded at each time step. This issue may be seen as a problem when decoding long sequences because it may make it difficult for the neural network to cope with long sentences, such as those that are longer than the sentences in the training corpus. Applying an attention mechanism, an LLM may predict the next word by searching for a set of positions in a source sentence where the most relevant information is concentrated. An LLM may then predict the next word based on context vectors associated with these source positions and all the previously generated target words, such as textual data of a dictionary correlated to a prompt in a training data set. A “context vector,” as used herein, are fixed-length vector representations useful for document retrieval and word sense disambiguation.

Still referring to FIG. 11, attention mechanism may include, without limitation, generalized attention self-attention, multi-head attention, additive attention, global attention, and the like. In generalized attention, when a sequence of words or an image is fed to an LLM, it may verify each element of the input sequence and compare it against the output sequence. Each iteration may involve the mechanism's encoder capturing the input sequence and comparing it with each element of the decoder's sequence. From the comparison scores, the mechanism may then select the words or parts of the image that it needs to pay attention to. In self-attention, an LLM may pick up particular parts at different positions in the input sequence and over time compute an initial composition of the output sequence. In multi-head attention, an LLM may include a transformer model of an attention mechanism. Attention mechanisms, as described above, may provide context for any position in the input sequence. For example, if the input data is a natural language sentence, the transformer does not have to process one word at a time. In multi-head attention, computations by an LLM may be repeated over several iterations, each computation may form parallel layers known as attention heads. Each separate head may independently pass the input sequence and corresponding output sequence element through a separate head. A final attention score may be produced by combining attention scores at each head so that every nuance of the input sequence is taken into consideration. In additive attention (Bahdanau attention mechanism), an LLM may make use of attention alignment scores based on a number of factors. Alignment scores may be calculated at different points in a neural network, and/or at different stages represented by discrete neural networks. Source or input sequence words are correlated with target or output sequence words but not to an exact degree. This correlation may take into account all hidden states and the final alignment score is the summation of the matrix of alignment scores. In global attention (Luong mechanism), in situations where neural machine translations are required, an LLM may either attend to all source words or predict the target sentence, thereby attending to a smaller subset of words.

Still referring to FIG. 11, multi-headed attention in encoder may apply a specific attention mechanism called self-attention. Self-attention allows models such as an LLM or components thereof to associate each word in the input, to other words. As a non-limiting example, an LLM may learn to associate the word “you”, with “how” and “are”. It's also possible that an LLM learns that words structured in this pattern are typically a question and to respond appropriately. In some embodiments, to achieve self-attention, input may be fed into three distinct fully connected neural network layers to create query, key, and value vectors. A query vector may include an entity's learned representation for comparison to determine attention score. A key vector may include an entity's learned representation for determining the entity's relevance and attention weight. A value vector may include data used to generate output representations. Query, key, and value vectors may be fed through a linear layer; then, the query and key vectors may be multiplied using dot product matrix multiplication in order to produce a score matrix. The score matrix may determine the amount of focus for a word should be put on other words (thus, each word may be a score that corresponds to other words in the time-step). The values in score matrix may be scaled down. As a non-limiting example, score matrix may be divided by the square root of the dimension of the query and key vectors. In some embodiments, the softmax of the scaled scores in score matrix may be taken. The output of this softmax function may be called the attention weights. Attention weights may be multiplied by your value vector to obtain an output vector. The output vector may then be fed through a final linear layer.

Still referencing FIG. 11, in order to use self-attention in a multi-headed attention computation, query, key, and value may be split into N vectors before applying self-attention. Each self-attention process may be called a “head.” Each head may produce an output vector and each output vector from each head may be concatenated into a single vector. This single vector may then be fed through the final linear layer discussed above. In theory, each head can learn something different from the input, therefore giving the encoder model more representation power.

Still referring to FIG. 11, encoder of transformer may include a residual connection. Residual connection may include adding the output from multi-headed attention to the positional input embedding. In some embodiments, the output from residual connection may go through a layer normalization. In some embodiments, the normalized residual output may be projected through a pointwise feed-forward network for further processing. The pointwise feed-forward network may include a couple of linear layers with a ReLU activation in between. The output may then be added to the input of the pointwise feed-forward network and further normalized.

Still referring to FIG. 11, transformer architecture may include a decoder. Decoder may a multi-headed attention layer, a pointwise feed-forward layer, one or more residual connections, and layer normalization (particularly after each sub-layer), as discussed in more detail above. In some embodiments, decoder may include two multi-headed attention layers. In some embodiments, decoder may be autoregressive. For the purposes of this disclosure, “autoregressive” means that the decoder takes in a list of previous outputs as inputs along with encoder outputs containing attention information from the input.

Still referring to FIG. 11, in some embodiments, input to decoder may go through an embedding layer and positional encoding layer in order to obtain positional embeddings. Decoder may include a first multi-headed attention layer, wherein the first multi-headed attention layer may receive positional embeddings.

Still referring to FIG. 11, first multi-headed attention layer may be configured to not condition to future tokens. As a non-limiting example, when computing attention scores on the word “am,” decoder should not have access to the word “fine” in “I am fine,” because that word is a future word that was generated after. The word “am” should only have access to itself and the words before it. In some embodiments, this may be accomplished by implementing a look-ahead mask. Look ahead mask is a matrix of the same dimensions as the scaled attention score matrix that is filled with “0s” and negative infinities. For example, the top right triangle portion of look-ahead mask may be filled with negative infinities. Look-ahead mask may be added to scaled attention score matrix to obtain a masked score matrix. Masked score matrix may include scaled attention scores in the lower-left triangle of the matrix and negative infinities in the upper-right triangle of the matrix. Then, when the softmax of this matrix is taken, the negative infinities will be zeroed out; this leaves zero attention scores for “future tokens.”

Still referring to FIG. 11, second multi-headed attention layer may use encoder outputs as queries and keys and the outputs from the first multi-headed attention layer as values. This process matches the encoder's input to the decoder's input, allowing the decoder to decide which encoder input is relevant to put a focus on. The output from second multi-headed attention layer may be fed through a pointwise feedforward layer for further processing.

Still referring to FIG. 11, the output of the pointwise feedforward layer may be fed through a final linear layer. This final linear layer may act as a classifier. This classifier may be as big as the number of classes that you have. For example, if you have 10,000 classes for 10,000 words, the output of that classifier will be of size 10,000. The output of this classifier may be fed into a softmax layer which may serve to produce probability scores between zero and one. The index may be taken of the highest probability score in order to determine a predicted word.

Still referring to FIG. 11, decoder may take this output and add it to the decoder inputs. Decoder may continue decoding until a token is predicted. Decoder may stop decoding once it predicts an end token.

Still referring to FIG. 11, in some embodiment, decoder may be stacked N layers high, with each layer taking in inputs from the encoder and layers before it. Stacking layers may allow an LLM to learn to extract and focus on different combinations of attention from its attention heads.

Still referring to FIG. 11, an LLM may receive an input. Input may include a string of one or more characters. Inputs may additionally include unstructured data. For example, input may include one or more words, a sentence, a paragraph, a thought, a query, and the like. A “query” for the purposes of the disclosure is a string of characters that poses a question. In some embodiments, input may be received from a user device. User device may be any computing device that is used by a user. As non-limiting examples, user device may include desktops, laptops, smartphones, tablets, and the like. In some embodiments, input may include audiovisual data.

Still referring to FIG. 11, an LLM may generate at least one annotation as an output. At least one annotation may be any annotation as described herein. In some embodiments, an LLM may include multiple sets of transformer architecture as described above. Output may include a textual output. A “textual output,” for the purposes of this disclosure is an output comprising a string of one or more characters. Textual output may include, for example, a plurality of annotations for unstructured data. In some embodiments, textual output may include a phrase or sentence identifying the status of a user query. In some embodiments, textual output may include a sentence or plurality of sentences describing a response to a user query. As a non-limiting example, this may include restrictions, timing, advice, dangers, benefits, and the like.

Still referring to FIG. 11, in some embodiments, audiovisual data 1128 may include video data. In some embodiments, determining emotional state 1132 of a user may include processing the video data using a machine vision system. A machine vision system may be used to detect, as examples, facial expression and/or body language of a user indicative of emotional state 1132 of the user. In some embodiments, audiovisual sensor 1124 includes a camera. System 1100 may, using a camera, capture an image of a user. An image may include a digital image. As used herein, a “camera” is a set of one or more devices configured to detect electromagnetic radiation. a camera may detect, in non-limiting examples, visible light, infrared light, and ultraviolet light. a camera may generate a representation of detected electromagnetic radiation, such as an image. In some cases, a camera may include one or more optics. Non-limiting examples of optics include spherical lenses, aspherical lenses, reflectors, polarizers, filters, windows, aperture stops, and the like. In some cases, a camera may include an image sensor. Exemplary non-limiting image sensors include digital image sensors, such as without limitation charge-coupled device (CCD) sensors and complimentary metal-oxide-semiconductor (CMOS) sensors, chemical image sensors, and analog image sensors, such as without limitation film. In some cases, a camera may be sensitive within a non-visible range of electromagnetic radiation, such as without limitation infrared. As used in this disclosure, “image data” is information representing at least a physical scene, space, and/or object. In some cases, image data may be generated by a camera. “Image data” may be used interchangeably through this disclosure with “image,” where image is used as a noun. An image may be optical, such as without limitation where at least an optic is used to generate an image of an object. An image may be material, such as without limitation when film is used to capture an image. An image may be digital, such as without limitation when represented as a bitmap. Alternatively, an image may be comprised of any media capable of representing a physical scene, space, and/or object. Alternatively, where “image” is used as a verb, in this disclosure, it refers to generation and/or formation of an image. In some embodiments, a camera may be configured to capture video.

Still referring to FIG. 11, in some embodiments, system 1100 may include a machine vision system. In some embodiments, a machine vision system may include at least a camera. A machine vision system may use images, such as images from at least a camera, to make a determination about a scene, space, and/or object. For example, in some cases a machine vision system may be used for world modeling or registration of objects within a space. In some cases, registration may include image processing, such as without limitation object recognition, feature detection, edge/corner detection, and the like. Non-limiting example of feature detection may include scale invariant feature transform (SIFT), Canny edge detection, Shi Tomasi corner detection, and the like. In some cases, registration may include one or more transformations to orient a camera frame (or an image or video stream) relative a three-dimensional coordinate system; exemplary transformations include without limitation homography transforms and affine transforms. In an embodiment, registration of first frame to a coordinate system may be verified and/or corrected using object identification and/or computer vision, as described above. For instance, and without limitation, an initial registration to two dimensions, represented for instance as registration to the x and y coordinates, may be performed using a two-dimensional projection of points in three dimensions onto a first frame, however. A third dimension of registration, representing depth and/or a z axis, may be detected by comparison of two frames; for instance, where first frame includes a pair of frames captured using a pair of cameras (e.g., stereoscopic camera also referred to in this disclosure as stereo-camera), image recognition and/or edge detection software may be used to detect a pair of stereoscopic views of images of an object; two stereoscopic views may be compared to derive z-axis values of points on object permitting, for instance, derivation of further z-axis points within and/or around the object using interpolation. This may be repeated with multiple objects in field of view, including without limitation environmental features of interest identified by object classifier and/or indicated by an operator. In an embodiment, x and y axes may be chosen to span a plane common to two cameras used for stereoscopic image capturing and/or an xy plane of a first frame; a result, x and y translational components and ø may be pre-populated in translational and rotational matrices, for affine transformation of coordinates of object, also as described above. Initial x and y coordinates and/or guesses at transformational matrices may alternatively or additionally be performed between first frame and second frame, as described above. For each point of a plurality of points on object and/or edge and/or edges of object as described above, x and y coordinates of a first stereoscopic frame may be populated, with an initial estimate of z coordinates based, for instance, on assumptions about object, such as an assumption that ground is substantially parallel to an xy plane as selected above. Z coordinates, and/or x, y, and z coordinates, registered using image capturing and/or object identification processes as described above may then be compared to coordinates predicted using initial guess at transformation matrices; an error function may be computed using by comparing the two sets of points, and new x, y, and/or z coordinates, may be iteratively estimated and compared until the error function drops below a threshold level. In some cases, a machine vision system may use a classifier, such as any classifier described throughout this disclosure.

Still referring to FIG. 11, an exemplary machine vision camera is an OpenMV Cam H7 from OpenMV, LLC of Atlanta, Georgia, U.S.A. OpenMV Cam comprises a small, low power, microcontroller which allows execution of machine vision applications. OpenMV Cam comprises an ARM Cortex M7 processor and a 640×480 image sensor operating at a frame rate up to 150 fps. OpenMV Cam may be programmed with Python using a Remote Python/Procedure Call (RPC) library. OpenMV CAM may be used to operate image classification and segmentation models, such as without limitation by way of TensorFlow Lite; detection motion, for example by way of frame differencing algorithms; marker detection, for example blob detection; object detection, for example face detection; eye tracking; person detection, for example by way of a trained machine learning model; camera motion detection, for example by way of optical flow detection; code (barcode) detection and decoding; image capture; and video recording.

Still referring to FIG. 11, in some embodiments, computing device 1108 may receive response 1116 and/or response time 1120 from user device 1104. In some embodiments, computing device 1108 may identify a minimum time 1140 necessary for a human to read and respond to prompt 1112 and/or maximum time 1144. Identification of minimum time 1140 and/or maximum time 1144 may be based on, for example, data representing population averages. In some embodiments, maximum time 1144 may be determined based on statistics representing response times at which a human response is subconscious and/or driven by emotion versus response times at which a human response is conscious, driven by intellect and/or not driven by emotion. Non-limiting examples of maximum times include 1 second, 2 seconds, 3 seconds, 4 seconds, 5 seconds, 6 seconds, 7 seconds, 8 seconds, 9 seconds, and 10 seconds. Exemplary methods of identification of minimum time 1140 and/or maximum time 1144 is described above with respect to FIG. 8.

Still referring to FIG. 11, in some embodiments, computing device 1108 may determine whether response 1116 is a qualifying response 1136 as a function of response time 1120 and minimum time 1140 necessary for a human to read and respond to prompt 1112. In some embodiments, response 1116 is determined not to be a qualifying response 1136 if response time 1120 is less than the minimum time 1140 necessary for a human to read and respond to prompt 1112. In some embodiments, response 1116 is determined not to be a qualifying response 1136 if response time 1120 is more than the maximum time 1144. In some embodiments, response 1116 is determined to be a qualifying response 1136 if response time 1120 is between minimum time 1140 and maximum time 1144. In some embodiments, computing device 1108 may determine a performance metric as a function of qualifying response 1136. As used herein, a “performance metric” is a datum describing an effectiveness of an individual, group, or system which promotes a particular product or service. For example, a performance metric may indicate the effectiveness with which a sales representative promotes a particular product or service. In some embodiments, a performance metric may be determined based on qualifying response 1136. In some embodiments, a performance metric may be determined based on qualifying responses 1136 and not based on responses determined not to be qualifying responses. In some embodiments, a performance metric may be determined based on differently weighted responses, where qualifying responses 1136 are weighted more heavily than responses determined not to be qualifying responses. In some embodiments, response 1116 is determined to be a qualifying response 1136 based on both response time 1120 and audiovisual data 1128. For example, text determined from audiovisual data may include a meaning which is interpreted. Such meaning may indicate a sentiment and/or level of an emotion within response 1116. For example, a large language model may be used to determine a degree to which response 1116 exhibits emotions such as anger. In another example, a sentiment analysis system may be used to determine a degree of positivity of response 1116. In some embodiments high degrees of positivity or negativity may be indicative of an emotional response. In another example, a machine vision system may be used to interpret body language and/or facial expressions of a user, and emotional state 1132 may be determined based on machine vision system outputs. In yet another non-limiting example, a response time that indicates a user has responded very quickly may indicate that the user is not fully engaged, and is looking to provide an answer quickly. In yet another non-limiting example, a response time that indicates a user has responded too slowly may indicate that a user has gone from an emotional response to an intellectual response. In some embodiments, determining whether the response 1116 is a qualifying response 1136 includes determining whether the response is an emotional response or an intellectual response. In some embodiments, a response time below a minimum time may indicate that the response is an emotional response. This may indicate that the response is not a qualifying response. In some embodiments, a response time above a minimum time may indicate that the response is an intellectual response. This may indicate that the response is a qualifying response. In some embodiments, determining whether the response 1116 is a qualifying response 1136 may include determining the response 1116 to be a qualifying response 1136 if the response is an intellectual response. In some embodiments, determining whether the response 1116 is an emotional response or an intellectual response may include the use of an LLM and/or a sentiment analysis system as described in this disclosure.

Still referring to FIG. 11, in some embodiments, computing device 1108 may be configured to transmit to user device 1104 emotional state 1132 of a user, such as a user of user device 1104. In some embodiments, user device 1104 may be configured to configure a digital avatar as a function of the emotional state, and display to the user the configured digital avatar. In some embodiments, user device 1104 may be configured to display to a user a digital avatar as a function of emotional state 1132 of a user.

Still referring to FIG. 11, in some embodiments, a digital avatar may include a base image and/or model and a plurality of animations of the base image and/or model. Such base image and/or model may be determined based on emotional state 1132. Digital avatar may be configured to display an animation of the plurality of animations as a function of emotional state 1132. As used herein, a “digital avatar” is an interactive character or entity in a virtual world. For example, a digital avatar may include a base image consisting of a computer-generated image associated with a user. As used herein, an “animation” is a form of digital medica production that includes using computer software to create moving images. For example, an avatar may be a 3 dimensional model that is capable of changing its shape with animations, such as human simulation animations like smiling or frowning. An animation may also include video clips and animated clips, such as short videos used on a website, which may be a part of a longer recording. For example, an animation may be stitched together into sequences by splicing together multiple animations (e.g., short videos) to create a new, original video/animation. In an embodiment, there may be one or more post-sequence static set ups for the digital avatar which may be still or in video format. For example, a digital avatar may have a resting, default face (e.g., not showing any sign of emotion) and an expression corresponding to a previous sequence may be added. For example, a digital avatar may initially present a resting, default face devoid of emotion and a smiling, happy expression corresponding to a previous sequence may be added. In yet another embodiment, each sequence may include a label representing each sequence to which responses and/or contexts could be matched. In an embodiment, instantiating digital avatar may include generating a plurality of rules linking events, such as receipt of response 1116, to animations. This may be accomplished by generating a model which includes generating a plurality of animations and a plurality of rules matching responses to animations or rules associating groups of responses to animations. For example, a response may be positive which may be linked to an animation of hands clapping. In another example, the way in which the digital avatar acts may be based on the context of an earlier input by a user and/or animation of a digital avatar. Configuring a digital avatar based on an emotional state may include, in non-limiting examples, selecting animations to play based on an emotional state (such as a clapping animation if the emotional state is happy), selecting effects such as lighting or particles to apply to the avatar or a digital space surrounding an avatar (such as a raining animation if the emotional state is sad), and/or selecting a digital avatar and/or a texture to apply to the digital avatar (such as selecting a digital avatar with a smiling neutral facial expression if the emotional state is not strongly in any direction).

Still referring to FIG. 11, in some embodiments, digital avatar may be customizable. For example, user may be able to cosmetically design an avatar and choose personalized characteristics. Digital avatar may include, without limitation, an animal, human, robot, inanimate object, or the like. In an embodiment, personalized characteristics may be also derived from user's behavior. For example, user may have a unique gait which may be incorporated by the digital avatar. Digital avatar may include one or more animation files and/or video clips and may include one or more files and/or video clips of the user.

Still referring to FIG. 11, in some embodiments, user device 1104 is configured to communicate to a user a plurality of prompts, receive a plurality of responses from the user, determine a plurality of response times, and transmit the plurality of responses and the plurality of response times to computing device 1108. In some embodiments, user computing device 1108 is configured to receive a plurality of responses and the plurality of response times from a user device and determine whether a response of the plurality of responses is a qualifying response as a function of each response time of the plurality of response times.

Still referring to FIG. 11, in some embodiments, system 1100 may be used to gather feedback from customers of a particular product and/or service. In some embodiments, feedback may be gathered from 100% of customers of such product and/or service. In some embodiments, system 1100 may be used to determine which responses are qualifying responses for 100% of feedback gathered by system 1100. For example, system 1100 may communicate prompts 1112 to customers, gather responses 1116, determine which responses 1116 are qualifying responses 1136 as a function of response time 1120, minimum time 1140, and/or maximum time 1144.

Referring now to FIG. 12, an exemplary embodiment of a machine-learning module 1200 that may perform one or more machine-learning processes as described in this disclosure is illustrated. Machine-learning module may perform determinations, classification, and/or analysis steps, methods, processes, or the like as described in this disclosure using machine learning processes. A “machine learning process,” as used in this disclosure, is a process that automatedly uses training data 1204 to generate an algorithm instantiated in hardware or software logic, data structures, and/or functions that will be performed by a computing device/module to produce outputs 1208 given data provided as inputs 1212; this is in contrast to a non-machine learning software program where the commands to be executed are determined in advance by a user and written in a programming language.

Still referring to FIG. 12, “training data,” as used herein, is data containing correlations that a machine-learning process may use to model relationships between two or more categories of data elements. For instance, and without limitation, training data 1204 may include a plurality of data entries, also known as “training examples,” each entry representing a set of data elements that were recorded, received, and/or generated together; data elements may be correlated by shared existence in a given data entry, by proximity in a given data entry, or the like. Multiple data entries in training data 1204 may evince one or more trends in correlations between categories of data elements; for instance, and without limitation, a higher value of a first data element belonging to a first category of data element may tend to correlate to a higher value of a second data element belonging to a second category of data element, indicating a possible proportional or other mathematical relationship linking values belonging to the two categories. Multiple categories of data elements may be related in training data 1204 according to various correlations; correlations may indicate causative and/or predictive links between categories of data elements, which may be modeled as relationships such as mathematical relationships by machine-learning processes as described in further detail below. Training data 1204 may be formatted and/or organized by categories of data elements, for instance by associating data elements with one or more descriptors corresponding to categories of data elements. As a non-limiting example, training data 1204 may include data entered in standardized forms by persons or processes, such that entry of a given data element in a given field in a form may be mapped to one or more descriptors of categories. Elements in training data 1204 may be linked to descriptors of categories by tags, tokens, or other data elements; for instance, and without limitation, training data 1204 may be provided in fixed-length formats, formats linking positions of data to categories such as comma-separated value (CSV) formats and/or self-describing formats such as extensible markup language (XML), JavaScript Object Notation (JSON), or the like, enabling processes or devices to detect categories of data.

Alternatively or additionally, and continuing to refer to FIG. 12, training data 1204 may include one or more elements that are not categorized; that is, training data 1204 may not be formatted or contain descriptors for some elements of data. Machine-learning algorithms and/or other processes may sort training data 1204 according to one or more categorizations using, for instance, natural language processing algorithms, tokenization, detection of correlated values in raw data and the like; categories may be generated using correlation and/or other processing algorithms. As a non-limiting example, in a corpus of text, phrases making up a number “n” of compound words, such as nouns modified by other nouns, may be identified according to a statistically significant prevalence of n-grams containing such words in a particular order; such an n-gram may be categorized as an element of language such as a “word” to be tracked similarly to single words, generating a new category as a result of statistical analysis. Similarly, in a data entry including some textual data, a person's name may be identified by reference to a list, dictionary, or other compendium of terms, permitting ad-hoc categorization by machine-learning algorithms, and/or automated association of data in the data entry with descriptors or into a given format. The ability to categorize data entries automatedly may enable the same training data 1204 to be made applicable for two or more distinct machine-learning algorithms as described in further detail below. Training data 1204 used by machine-learning module 1200 may correlate any input data as described in this disclosure to any output data as described in this disclosure. As a non-limiting illustrative example inputs may include audio data and outputs may include transcripts of such audio data.

Further referring to FIG. 12, training data may be filtered, sorted, and/or selected using one or more supervised and/or unsupervised machine-learning processes and/or models as described in further detail below; such models may include without limitation a training data classifier 1216. Training data classifier 1216 may include a “classifier,” which as used in this disclosure is a machine-learning model as defined below, such as a data structure representing and/or using a mathematical model, neural net, or program generated by a machine learning algorithm known as a “classification algorithm,” as described in further detail below, that sorts inputs into categories or bins of data, outputting the categories or bins of data and/or labels associated therewith. A classifier may be configured to output at least a datum that labels or otherwise identifies a set of data that are clustered together, found to be close under a distance metric as described below, or the like. A distance metric may include any norm, such as, without limitation, a Pythagorean norm. Machine-learning module 1200 may generate a classifier using a classification algorithm, defined as a processes whereby a computing device and/or any module and/or component operating thereon derives a classifier from training data 1204. Classification may be performed using, without limitation, linear classifiers such as without limitation logistic regression and/or naive Bayes classifiers, nearest neighbor classifiers such as k-nearest neighbors classifiers, support vector machines, least squares support vector machines, fisher's linear discriminant, quadratic classifiers, decision trees, boosted trees, random forest classifiers, learning vector quantization, and/or neural network-based classifiers. As a non-limiting example, training data classifier 1216 may classify elements of training data to a particular language.

Still referring to FIG. 12, Computing device may be configured to generate a classifier using a Naïve Bayes classification algorithm. Naïve Bayes classification algorithm generates classifiers by assigning class labels to problem instances, represented as vectors of element values. Class labels are drawn from a finite set. Naïve Bayes classification algorithm may include generating a family of algorithms that assume that the value of a particular element is independent of the value of any other element, given a class variable. Naïve Bayes classification algorithm may be based on Bayes Theorem expressed as P(A/B)=P(B/A) P(A)÷P(B), where P(A/B) is the probability of hypothesis A given data B also known as posterior probability; P(B/A) is the probability of data B given that the hypothesis A was true; P(A) is the probability of hypothesis A being true regardless of data also known as prior probability of A; and P(B) is the probability of the data regardless of the hypothesis. A naïve Bayes algorithm may be generated by first transforming training data into a frequency table. Computing device may then calculate a likelihood table by calculating probabilities of different data entries and classification labels. Computing device may utilize a naïve Bayes equation to calculate a posterior probability for each class. A class containing the highest posterior probability is the outcome of prediction. Naïve Bayes classification algorithm may include a gaussian model that follows a normal distribution. Naïve Bayes classification algorithm may include a multinomial model that is used for discrete counts. Naïve Bayes classification algorithm may include a Bernoulli model that may be utilized when vectors are binary.

With continued reference to FIG. 12, Computing device may be configured to generate a classifier using a K-nearest neighbors (KNN) algorithm. A “K-nearest neighbors algorithm” as used in this disclosure, includes a classification method that utilizes feature similarity to analyze how closely out-of-sample-features resemble training data to classify input data to one or more clusters and/or categories of features as represented in training data; this may be performed by representing both training data and input data in vector forms, and using one or more measures of vector similarity to identify classifications within training data, and to determine a classification of input data. K-nearest neighbors algorithm may include specifying a K-value, or a number directing the classifier to select the k most similar entries training data to a given sample, determining the most common classifier of the entries in the database, and classifying the known sample; this may be performed recursively and/or iteratively to generate a classifier that may be used to classify input data as further samples. For instance, an initial set of samples may be performed to cover an initial heuristic and/or “first guess” at an output and/or relationship, which may be seeded, without limitation, using expert input received according to any process as described herein. As a non-limiting example, an initial heuristic may include a ranking of associations between inputs and elements of training data. Heuristic may include selecting some number of highest-ranking associations and/or training data elements.

With continued reference to FIG. 12, generating k-nearest neighbors algorithm may generate a first vector output containing a data entry cluster, generating a second vector output containing an input data, and calculate the distance between the first vector output and the second vector output using any suitable norm such as cosine similarity, Euclidean distance measurement, or the like. Each vector output may be represented, without limitation, as an n-tuple of values, where n is at least two values. Each value of n-tuple of values may represent a measurement or other quantitative value associated with a given category of data, or attribute, examples of which are provided in further detail below; a vector may be represented, without limitation, in n-dimensional space using an axis per category of value represented in n-tuple of values, such that a vector has a geometric direction characterizing the relative quantities of attributes in the n-tuple as compared to each other. Two vectors may be considered equivalent where their directions, and/or the relative quantities of values within each vector as compared to each other, are the same; thus, as a non-limiting example, a vector represented as [5, 10, 15] may be treated as equivalent, for purposes of this disclosure, as a vector represented as [1, 2, 3]. Vectors may be more similar where their directions are more similar, and more different where their directions are more divergent; however, vector similarity may alternatively or additionally be determined using averages of similarities between like attributes, or any other measure of similarity suitable for any n-tuple of values, or aggregation of numerical similarity measures for the purposes of loss functions as described in further detail below. Any vectors as described herein may be scaled, such that each vector represents each attribute along an equivalent scale of values. Each vector may be “normalized,” or divided by a “length” attribute, such as a length attribute/as derived using a Pythagorean norm:

$$l = \sqrt{{\sum }_{i = 0}^{n} {a}_{i}^{2}} ,$$

where aᵢ is attribute number i of the vector. Scaling and/or normalization may function to make vector comparison independent of absolute quantities of attributes, while preserving any dependency on similarity of attributes; this may, for instance, be advantageous where cases represented in training data are represented by different quantities of samples, which may result in proportionally equivalent vectors with divergent values.

With further reference to FIG. 12, training examples for use as training data may be selected from a population of potential examples according to cohorts relevant to an analytical problem to be solved, a classification task, or the like. Alternatively or additionally, training data may be selected to span a set of likely circumstances or inputs for a machine-learning model and/or process to encounter when deployed. For instance, and without limitation, for each category of input data to a machine-learning process or model that may exist in a range of values in a population of phenomena such as images, user data, process data, physical data, or the like, a computing device, processor, and/or machine-learning model may select training examples representing each possible value on such a range and/or a representative sample of values on such a range. Selection of a representative sample may include selection of training examples in proportions matching a statistically determined and/or predicted distribution of such values according to relative frequency, such that, for instance, values encountered more frequently in a population of data so analyzed are represented by more training examples than values that are encountered less frequently. Alternatively or additionally, a set of training examples may be compared to a collection of representative values in a database and/or presented to a user, so that a process can detect, automatically or via user input, one or more values that are not included in the set of training examples. Computing device, processor, and/or module may automatically generate a missing training example; this may be done by receiving and/or retrieving a missing input and/or output value and correlating the missing input and/or output value with a corresponding output and/or input value collocated in a data record with the retrieved value, provided by a user and/or other device, or the like.

Continuing to refer to FIG. 12, computer, processor, and/or module may be configured to preprocess training data. “Preprocessing” training data, as used in this disclosure, is transforming training data from raw form to a format that can be used for training a machine learning model. Preprocessing may include sanitizing, feature selection, feature scaling, data augmentation and the like.

Still referring to FIG. 12, computer, processor, and/or module may be configured to sanitize training data. “Sanitizing” training data, as used in this disclosure, is a process whereby training examples are removed that interfere with convergence of a machine-learning model and/or process to a useful result. For instance, and without limitation, a training example may include an input and/or output value that is an outlier from typically encountered values, such that a machine-learning algorithm using the training example will be adapted to an unlikely amount as an input and/or output; a value that is more than a threshold number of standard deviations away from an average, mean, or expected value, for instance, may be eliminated. Alternatively or additionally, one or more training examples may be identified as having poor quality data, where “poor quality” is defined as having a signal to noise ratio below a threshold value. Sanitizing may include steps such as removing duplicative or otherwise redundant data, interpolating missing data, correcting data errors, standardizing data, identifying outliers, and the like. In a nonlimiting example, sanitization may include utilizing algorithms for identifying duplicate entries or spell-check algorithms.

As a non-limiting example, and with further reference to FIG. 12, images used to train an image classifier or other machine-learning model and/or process that takes images as inputs or generates images as outputs may be rejected if image quality is below a threshold value. For instance, and without limitation, computing device, processor, and/or module may perform blur detection, and eliminate one or more Blur detection may be performed, as a non-limiting example, by taking Fourier transform, or an approximation such as a Fast Fourier Transform (FFT) of the image and analyzing a distribution of low and high frequencies in the resulting frequency-domain depiction of the image; numbers of high-frequency values below a threshold level may indicate blurriness. As a further non-limiting example, detection of blurriness may be performed by convolving an image, a channel of an image, or the like with a Laplacian kernel; this may generate a numerical score reflecting a number of rapid changes in intensity shown in the image, such that a high score indicates clarity and a low score indicates blurriness. Blurriness detection may be performed using a gradient-based operator, which measures operators based on the gradient or first derivative of an image, based on the hypothesis that rapid changes indicate sharp edges in the image, and thus are indicative of a lower degree of blurriness. Blur detection may be performed using Wavelet-based operator, which takes advantage of the capability of coefficients of the discrete wavelet transform to describe the frequency and spatial content of images. Blur detection may be performed using statistics-based operators take advantage of several image statistics as texture descriptors in order to compute a focus level. Blur detection may be performed by using discrete cosine transform (DCT) coefficients in order to compute a focus level of an image from its frequency content.

Continuing to refer to FIG. 12, computing device, processor, and/or module may be configured to precondition one or more training examples. For instance, and without limitation, where a machine learning model and/or process has one or more inputs and/or outputs requiring, transmitting, or receiving a certain number of bits, samples, or other units of data, one or more training examples' elements to be used as or compared to inputs and/or outputs may be modified to have such a number of units of data. For instance, a computing device, processor, and/or module may convert a smaller number of units, such as in a low pixel count image, into a desired number of units, for instance by upsampling and interpolating. As a non-limiting example, a low pixel count image may have 100 pixels, however a desired number of pixels may be 128. Processor may interpolate the low pixel count image to convert the 100 pixels into 128 pixels. It should also be noted that one of ordinary skill in the art, upon reading this disclosure, would know the various methods to interpolate a smaller number of data units such as samples, pixels, bits, or the like to a desired number of such units. In some instances, a set of interpolation rules may be trained by sets of highly detailed inputs and/or outputs and corresponding inputs and/or outputs downsampled to smaller numbers of units, and a neural network or other machine learning model that is trained to predict interpolated pixel values using the training data. As a non-limiting example, a sample input and/or output, such as a sample picture, with sample-expanded data units (e.g., pixels added between the original pixels) may be input to a neural network or machine-learning model and output a pseudo replica sample-picture with dummy values assigned to pixels between the original pixels based on a set of interpolation rules. As a non-limiting example, in the context of an image classifier, a machine-learning model may have a set of interpolation rules trained by sets of highly detailed images and images that have been downsampled to smaller numbers of pixels, and a neural network or other machine learning model that is trained using those examples to predict interpolated pixel values in a facial picture context. As a result, an input with sample-expanded data units (the ones added between the original data units, with dummy values) may be run through a trained neural network and/or model, which may fill in values to replace the dummy values. Alternatively or additionally, processor, computing device, and/or module may utilize sample expander methods, a low-pass filter, or both. As used in this disclosure, a “low-pass filter” is a filter that passes signals with a frequency lower than a selected cutoff frequency and attenuates signals with frequencies higher than the cutoff frequency. The exact frequency response of the filter depends on the filter design. Computing device, processor, and/or module may use averaging, such as luma or chroma averaging in images, to fill in data units in between original data units.

In some embodiments, and with continued reference to FIG. 12, computing device, processor, and/or module may down-sample elements of a training example to a desired lower number of data elements. As a non-limiting example, a high pixel count image may have 256 pixels, however a desired number of pixels may be 128. Processor may down-sample the high pixel count image to convert the 256 pixels into 128 pixels. In some embodiments, processor may be configured to perform downsampling on data. Downsampling, also known as decimation, may include removing every Nth entry in a sequence of samples, all but every Nth entry, or the like, which is a process known as “compression,” and may be performed, for instance by an N-sample compressor implemented using hardware or software. Anti-aliasing and/or anti-imaging filters, and/or low-pass filters, may be used to clean up side-effects of compression.

Further referring to FIG. 12, feature selection includes narrowing and/or filtering training data to exclude features and/or elements, or training data including such elements, that are not relevant to a purpose for which a trained machine-learning model and/or algorithm is being trained, and/or collection of features and/or elements, or training data including such elements, on the basis of relevance or utility for an intended task or purpose for a trained machine-learning model and/or algorithm is being trained. Feature selection may be implemented, without limitation, using any process described in this disclosure, including without limitation using training data classifiers, exclusion of outliers, or the like.

With continued reference to FIG. 12, feature scaling may include, without limitation, normalization of data entries, which may be accomplished by dividing numerical fields by norms thereof, for instance as performed for vector normalization. Feature scaling may include absolute maximum scaling, wherein each quantitative datum is divided by the maximum absolute value of all quantitative data of a set or subset of quantitative data. Feature scaling may include min-max scaling, in which each value X has a minimum value Xₘᵢₙ in a set or subset of values subtracted therefrom, with the result divided by the range of the values, give maximum value in the set or subset

$${X}_{max} : {X}_{new} = \frac{X - {X}_{min}}{{X}_{max} - {X}_{min}} .$$

Feature scaling may include mean normalization, which involves use of a mean value of a set and/or subset of values, Xₘₑₐₙ with maximum and minimum values:

$${X}_{new} = \frac{X - {X}_{mean}}{{X}_{max} - {X}_{min}} .$$

Feature scaling may include standardization, where a difference between X and Xₘₑₐₙ is divided by a standard deviation σ of a set or subset of values:

$${X}_{new} = \frac{X - {X}_{mean}}{σ} .$$

Scaling may be performed using a median value of a a set or subset X_{median} and/or interquartile range (IQR), which represents the difference between the 25^{th} percentile value and the 50^{th} percentile value (or closest values thereto by a rounding protocol), such as:

$${X}_{new} = \frac{X - {X}_{median}}{IQR} .$$

Persons skilled in the art, upon reviewing the entirety of this disclosure, will be aware of various alternative or additional approaches that may be used for feature scaling.

Further referring to FIG. 12, computing device, processor, and/or module may be configured to perform one or more processes of data augmentation. “Data augmentation” as used in this disclosure is addition of data to a training set using elements and/or entries already in the dataset. Data augmentation may be accomplished, without limitation, using interpolation, generation of modified copies of existing entries and/or examples, and/or one or more generative AI processes, for instance using deep neural networks and/or generative adversarial networks; generative processes may be referred to alternatively in this context as “data synthesis” and as creating “synthetic data.” Augmentation may include performing one or more transformations on data, such as geometric, color space, affine, brightness, cropping, and/or contrast transformations of images.

Still referring to FIG. 12, machine-learning module 1200 may be configured to perform a lazy-learning process 1220 and/or protocol, which may alternatively be referred to as a “lazy loading” or “call-when-needed” process and/or protocol, may be a process whereby machine learning is conducted upon receipt of an input to be converted to an output, by combining the input and training set to derive the algorithm to be used to produce the output on demand. For instance, an initial set of simulations may be performed to cover an initial heuristic and/or “first guess” at an output and/or relationship. As a non-limiting example, an initial heuristic may include a ranking of associations between inputs and elements of training data 1204. Heuristic may include selecting some number of highest-ranking associations and/or training data 1204 elements. Lazy learning may implement any suitable lazy learning algorithm, including without limitation a K-nearest neighbors algorithm, a lazy naïve Bayes algorithm, or the like; persons skilled in the art, upon reviewing the entirety of this disclosure, will be aware of various lazy-learning algorithms that may be applied to generate outputs as described in this disclosure, including without limitation lazy learning applications of machine-learning algorithms as described in further detail below.

Alternatively or additionally, and with continued reference to FIG. 12, machine-learning processes as described in this disclosure may be used to generate machine-learning models 1224. A “machine-learning model,” as used in this disclosure, is a data structure representing and/or instantiating a mathematical and/or algorithmic representation of a relationship between inputs and outputs, as generated using any machine-learning process including without limitation any process as described above, and stored in memory; an input is submitted to a machine-learning model 1224 once created, which generates an output based on the relationship that was derived. For instance, and without limitation, a linear regression model, generated using a linear regression algorithm, may compute a linear combination of input data using coefficients derived during machine-learning processes to calculate an output datum. As a further non-limiting example, a machine-learning model 1224 may be generated by creating an artificial neural network, such as a convolutional neural network comprising an input layer of nodes, one or more intermediate layers, and an output layer of nodes. Connections between nodes may be created via the process of “training” the network, in which elements from a training data 1204 set are applied to the input nodes, a suitable training algorithm (such as Levenberg-Marquardt, conjugate gradient, simulated annealing, or other algorithms) is then used to adjust the connections and weights between nodes in adjacent layers of the neural network to produce the desired values at the output nodes. This process is sometimes referred to as deep learning.

Still referring to FIG. 12, machine-learning algorithms may include at least a supervised machine-learning process 1228. At least a supervised machine-learning process 1228, as defined herein, include algorithms that receive a training set relating a number of inputs to a number of outputs, and seek to generate one or more data structures representing and/or instantiating one or more mathematical relations relating inputs to outputs, where each of the one or more mathematical relations is optimal according to some criterion specified to the algorithm using some scoring function. For instance, a supervised learning algorithm may include audio data as described above as inputs, transcripts as outputs, and a scoring function representing a desired form of relationship to be detected between inputs and outputs; scoring function may, for instance, seek to maximize the probability that a given input and/or combination of elements inputs is associated with a given output to minimize the probability that a given input is not associated with a given output. Scoring function may be expressed as a risk function representing an “expected loss” of an algorithm relating inputs to outputs, where loss is computed as an error function representing a degree to which a prediction generated by the relation is incorrect when compared to a given input-output pair provided in training data 1204. Persons skilled in the art, upon reviewing the entirety of this disclosure, will be aware of various possible variations of at least a supervised machine-learning process 1228 that may be used to determine relation between inputs and outputs. Supervised machine-learning processes may include classification algorithms as defined above.

With further reference to FIG. 12, training a supervised machine-learning process may include, without limitation, iteratively updating coefficients, biases, weights based on an error function, expected loss, and/or risk function. For instance, an output generated by a supervised machine-learning model using an input example in a training example may be compared to an output example from the training example; an error function may be generated based on the comparison, which may include any error function suitable for use with any machine-learning algorithm described in this disclosure, including a square of a difference between one or more sets of compared values or the like. Such an error function may be used in turn to update one or more weights, biases, coefficients, or other parameters of a machine-learning model through any suitable process including without limitation gradient descent processes, least-squares processes, and/or other processes described in this disclosure. This may be done iteratively and/or recursively to gradually tune such weights, biases, coefficients, or other parameters. Updating may be performed, in neural networks, using one or more back-propagation algorithms. Iterative and/or recursive updates to weights, biases, coefficients, or other parameters as described above may be performed until currently available training data is exhausted and/or until a convergence test is passed, where a “convergence test” is a test for a condition selected as indicating that a model and/or weights, biases, coefficients, or other parameters thereof has reached a degree of accuracy. A convergence test may, for instance, compare a difference between two or more successive errors or error function values, where differences below a threshold amount may be taken to indicate convergence. Alternatively or additionally, one or more errors and/or error function values evaluated in training iterations may be compared to a threshold.

Still referring to FIG. 12, a computing device, processor, and/or module may be configured to perform method, method step, sequence of method steps and/or algorithm described in reference to this figure, in any order and with any degree of repetition. For instance, a computing device, processor, and/or module may be configured to perform a single step, sequence and/or algorithm repeatedly until a desired or commanded outcome is achieved; repetition of a step or a sequence of steps may be performed iteratively and/or recursively using outputs of previous repetitions as inputs to subsequent repetitions, aggregating inputs and/or outputs of repetitions to produce an aggregate result, reduction or decrement of one or more variables such as global variables, and/or division of a larger processing task into a set of iteratively addressed smaller processing tasks. A computing device, processor, and/or module may perform any step, sequence of steps, or algorithm in parallel, such as simultaneously and/or substantially simultaneously performing a step two or more times using two or more parallel threads, processor cores, or the like; division of tasks between parallel threads and/or processes may be performed according to any protocol suitable for division of tasks between iterations. Persons skilled in the art, upon reviewing the entirety of this disclosure, will be aware of various ways in which steps, sequences of steps, processing tasks, and/or data may be subdivided, shared, or otherwise dealt with using iteration, recursion, and/or parallel processing.

Further referring to FIG. 12, machine learning processes may include at least an unsupervised machine-learning processes 1232. An unsupervised machine-learning process, as used herein, is a process that derives inferences in datasets without regard to labels; as a result, an unsupervised machine-learning process may be free to discover any structure, relationship, and/or correlation provided in the data. Unsupervised processes 1232 may not require a response variable; unsupervised processes 1232 may be used to find interesting patterns and/or inferences between variables, to determine a degree of correlation between two or more variables, or the like.

Still referring to FIG. 12, machine-learning module 1200 may be designed and configured to create a machine-learning model 1224 using techniques for development of linear regression models. Linear regression models may include ordinary least squares regression, which aims to minimize the square of the difference between predicted outcomes and actual outcomes according to an appropriate norm for measuring such a difference (e.g. a vector-space distance norm); coefficients of the resulting linear equation may be modified to improve minimization. Linear regression models may include ridge regression methods, where the function to be minimized includes the least-squares function plus term multiplying the square of each coefficient by a scalar amount to penalize large coefficients. Linear regression models may include least absolute shrinkage and selection operator (LASSO) models, in which ridge regression is combined with multiplying the least-squares term by a factor of 1 divided by double the number of samples. Linear regression models may include a multi-task lasso model wherein the norm applied in the least-squares term of the lasso model is the Frobenius norm amounting to the square root of the sum of squares of all terms. Linear regression models may include the clastic net model, a multi-task elastic net model, a least angle regression model, a LARS lasso model, an orthogonal matching pursuit model, a Bayesian regression model, a logistic regression model, a stochastic gradient descent model, a perceptron model, a passive aggressive algorithm, a robustness regression model, a Huber regression model, or any other suitable model that may occur to persons skilled in the art upon reviewing the entirety of this disclosure. Linear regression models may be generalized in an embodiment to polynomial regression models, whereby a polynomial equation (e.g. a quadratic, cubic or higher-order equation) providing a best predicted output/actual output fit is sought; similar methods to those described above may be applied to minimize error functions, as will be apparent to persons skilled in the art upon reviewing the entirety of this disclosure.

Continuing to refer to FIG. 12, machine-learning algorithms may include, without limitation, linear discriminant analysis. Machine-learning algorithm may include quadratic discriminant analysis. Machine-learning algorithms may include kernel ridge regression. Machine-learning algorithms may include support vector machines, including without limitation support vector classification-based regression processes. Machine-learning algorithms may include stochastic gradient descent algorithms, including classification and regression algorithms based on stochastic gradient descent. Machine-learning algorithms may include nearest neighbors algorithms. Machine-learning algorithms may include various forms of latent space regularization such as variational regularization. Machine-learning algorithms may include Gaussian processes such as Gaussian Process Regression. Machine-learning algorithms may include cross-decomposition algorithms, including partial least squares and/or canonical correlation analysis. Machine-learning algorithms may include naïve Bayes methods. Machine-learning algorithms may include algorithms based on decision trees, such as decision tree classification or regression algorithms. Machine-learning algorithms may include ensemble methods such as bagging meta-estimator, forest of randomized trees, AdaBoost, gradient tree boosting, and/or voting classifier methods. Machine-learning algorithms may include neural net algorithms, including convolutional neural net processes.

Still referring to FIG. 12, a machine-learning model and/or process may be deployed or instantiated by incorporation into a program, apparatus, system and/or module. For instance, and without limitation, a machine-learning model, neural network, and/or some or all parameters thereof may be stored and/or deployed in any memory or circuitry. Parameters such as coefficients, weights, and/or biases may be stored as circuit-based constants, such as arrays of wires and/or binary inputs and/or outputs set at logic “1” and “0” voltage levels in a logic circuit to represent a number according to any suitable encoding system including twos complement or the like or may be stored in any volatile and/or non-volatile memory. Similarly, mathematical operations and input and/or output of data to or from models, neural network layers, or the like may be instantiated in hardware circuitry and/or in the form of instructions in firmware, machine-code such as binary operation code instructions, assembly language, or any higher-order programming language. Any technology for hardware and/or software instantiation of memory, instructions, data structures, and/or algorithms may be used to instantiate a machine-learning process and/or model, including without limitation any combination of production and/or configuration of non-reconfigurable hardware elements, circuits, and/or modules such as without limitation ASICs, production and/or configuration of reconfigurable hardware elements, circuits, and/or modules such as without limitation FPGAs, production and/or of non-reconfigurable and/or configuration non-rewritable memory elements, circuits, and/or modules such as without limitation non-rewritable ROM, production and/or configuration of reconfigurable and/or rewritable memory elements, circuits, and/or modules such as without limitation rewritable ROM or other memory technology described in this disclosure, and/or production and/or configuration of any computing device and/or component thereof as described in this disclosure. Such deployed and/or instantiated machine-learning model and/or algorithm may receive inputs from any other process, module, and/or component described in this disclosure, and produce outputs to any other process, module, and/or component described in this disclosure.

Continuing to refer to FIG. 12, any process of training, retraining, deployment, and/or instantiation of any machine-learning model and/or algorithm may be performed and/or repeated after an initial deployment and/or instantiation to correct, refine, and/or improve the machine-learning model and/or algorithm. Such retraining, deployment, and/or instantiation may be performed as a periodic or regular process, such as retraining, deployment, and/or instantiation at regular elapsed time periods, after some measure of volume such as a number of bytes or other measures of data processed, a number of uses or performances of processes described in this disclosure, or the like, and/or according to a software, firmware, or other update schedule. Alternatively or additionally, retraining, deployment, and/or instantiation may be event-based, and may be triggered, without limitation, by user inputs indicating sub-optimal or otherwise problematic performance and/or by automated field testing and/or auditing processes, which may compare outputs of machine-learning models and/or algorithms, and/or errors and/or error functions thereof, to any thresholds, convergence tests, or the like, and/or may compare outputs of processes described herein to similar thresholds, convergence tests or the like. Event-based retraining, deployment, and/or instantiation may alternatively or additionally be triggered by receipt and/or generation of one or more new training examples; a number of new training examples may be compared to a preconfigured threshold, where exceeding the preconfigured threshold may trigger retraining, deployment, and/or instantiation.

Still referring to FIG. 12, retraining and/or additional training may be performed using any process for training described above, using any currently or previously deployed version of a machine-learning model and/or algorithm as a starting point. Training data for retraining may be collected, preconditioned, sorted, classified, sanitized or otherwise processed according to any process described in this disclosure. Training data may include, without limitation, training examples including inputs and correlated outputs used, received, and/or generated from any version of any system, module, machine-learning model or algorithm, apparatus, and/or method described in this disclosure; such examples may be modified and/or labeled according to user feedback or other processes to indicate desired results, and/or may have actual or measured results from a process being modeled and/or predicted by system, module, machine-learning model or algorithm, apparatus, and/or method as “desired” results to be compared to outputs for training processes as described above.

Redeployment may be performed using any reconfiguring and/or rewriting of reconfigurable and/or rewritable circuit and/or memory elements; alternatively, redeployment may be performed by production of new hardware and/or software components, circuits, instructions, or the like, which may be added to and/or may replace existing hardware and/or software components, circuits, instructions, or the like.

Further referring to FIG. 12, one or more processes or algorithms described above may be performed by at least a dedicated hardware unit 1236. A “dedicated hardware unit,” for the purposes of this figure, is a hardware component, circuit, or the like, aside from a principal control circuit and/or processor performing method steps as described in this disclosure, that is specifically designated or selected to perform one or more specific tasks and/or processes described in reference to this figure, such as without limitation preconditioning and/or sanitization of training data and/or training a machine-learning algorithm and/or model. A dedicated hardware unit 1236 may include, without limitation, a hardware unit that can perform iterative or massed calculations, such as matrix-based calculations to update or tune parameters, weights, coefficients, and/or biases of machine-learning models and/or neural networks, efficiently using pipelining, parallel processing, or the like; such a hardware unit may be optimized for such processes by, for instance, including dedicated circuitry for matrix and/or signal processing operations that includes, e.g., multiple arithmetic and/or logical circuit units such as multipliers and/or adders that can act simultaneously and/or in parallel or the like. Such dedicated hardware units 1236 may include, without limitation, graphical processing units (GPUs), dedicated signal processing modules, FPGA or other reconfigurable hardware that has been configured to instantiate parallel processing units for one or more specific tasks, or the like, A computing device, processor, apparatus, or module may be configured to instruct one or more dedicated hardware units 1236 to perform one or more operations described herein, such as evaluation of model and/or algorithm outputs, one-time or iterative updates to parameters, coefficients, weights, and/or biases, and/or any other operations such as vector and/or matrix operations as described in this disclosure.

With continued reference to FIG. 12, system 1100 may use user feedback to train the machine-learning models and/or classifiers described above. For example, classifier may be trained using past inputs and outputs of classifier. In some embodiments, if user feedback indicates that an output of classifier was “bad,” then that output and the corresponding input may be removed from training data used to train classifier, and/or may be replaced with a value entered by, e.g., another user that represents an ideal output given the input the classifier originally received, permitting use in retraining, and adding to training data; in either case, classifier may be retrained with modified training data as described in further detail below. In some embodiments, training data of classifier may include user feedback.

With continued reference to FIG. 12, in some embodiments, an accuracy score may be calculated for classifier using user feedback. For the purposes of this disclosure, “accuracy score,” is a numerical value concerning the accuracy of a machine-learning model. For example, a plurality of user feedback scores may be averaged to determine an accuracy score. In some embodiments, a cohort accuracy score may be determined for particular cohorts of persons. For example, user feedback for users belonging to a particular cohort of persons may be averaged together to determine the cohort accuracy score for that particular cohort of persons and used as described above. Accuracy score or another score as described above may indicate a degree of retraining needed for a machine-learning model such as a classifier; system 1100 may perform a larger number of retraining cycles for a higher number (or lower number, depending on a numerical interpretation used), and/or may collect more training data for such retraining, perform more training cycles, apply a more stringent convergence test such as a test requiring a lower mean squared error, and/or indicate to a user and/or operator that additional training data is needed.

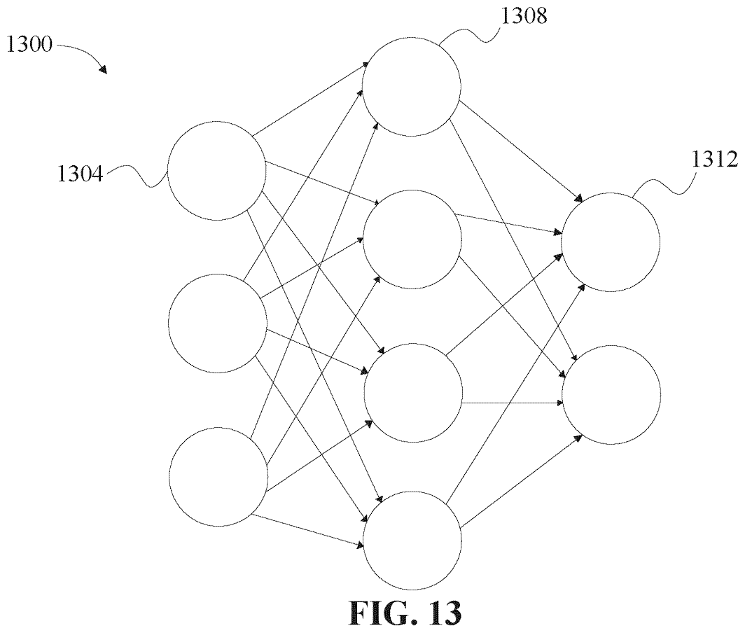

Referring now to FIG. 13, an exemplary embodiment of neural network 1300 is illustrated. A neural network 1300 also known as an artificial neural network, is a network of “nodes,” or data structures having one or more inputs, one or more outputs, and a function determining outputs based on inputs. Such nodes may be organized in a network, such as without limitation a convolutional neural network, including an input layer of nodes 1304, one or more intermediate layers 1308, and an output layer of nodes 1312. Connections between nodes may be created via the process of “training” the network, in which elements from a training dataset are applied to the input nodes, a suitable training algorithm (such as Levenberg-Marquardt, conjugate gradient, simulated annealing, or other algorithms) is then used to adjust the connections and weights between nodes in adjacent layers of the neural network to produce the desired values at the output nodes. This process is sometimes referred to as deep learning. Connections may run solely from input nodes toward output nodes in a “feed-forward” network, or may feed outputs of one layer back to inputs of the same or a different layer in a “recurrent network.” As a further non-limiting example, a neural network may include a convolutional neural network comprising an input layer of nodes, one or more intermediate layers, and an output layer of nodes.

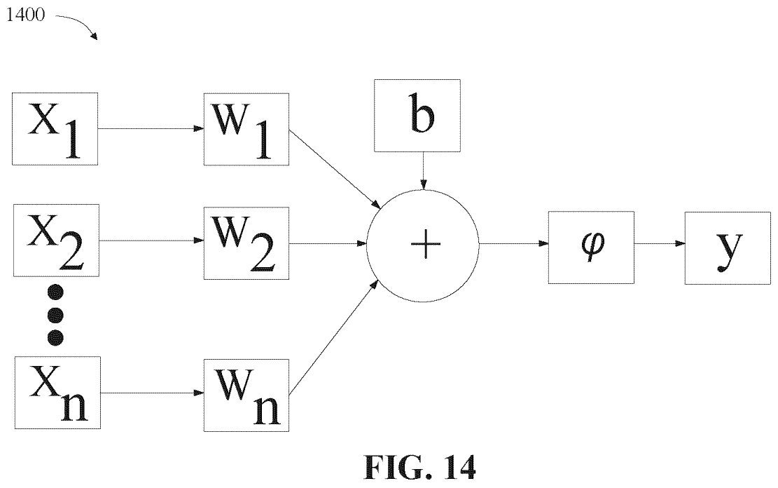

Referring now to FIG. 14, an exemplary embodiment of a node 1400 of a neural network is illustrated. A node may include, without limitation a plurality of inputs x; that may receive numerical values from inputs to a neural network containing the node and/or from other nodes. Node may perform one or more activation functions to produce its output given one or more inputs, such as without limitation computing a binary step function comparing an input to a threshold value and outputting either a logic 1 or logic 0 output or something equivalent, a linear activation function whereby an output is directly proportional to the input, and/or a non-linear activation function, wherein the output is not proportional to the input. Non-linear activation functions may include, without limitation, a sigmoid function of the form

$$f ( x ) = \frac{1}{1 - {e}^{- x}}$$

given input x, a tan h (hyperbolic tangent) function, of the form

$$\frac{{e}^{x} - {e}^{- x}}{{e}^{x} + {e}^{- x}} ,$$

a tan h derivative function such as ƒ(x)=tan h²(x), a rectified linear unit function such as ƒ(x)=max(0, x), a “leaky” and/or “parametric” rectified linear unit function such as ƒ(x)=max(ax, x) for some a, an exponential linear units function such as

$$f ( x ) = \{ \begin{matrix}x for x \geq 0 \\ α ( {e}^{x} - 1 ) for x < 0\end{matrix}$$

for some value of α (this function may be replaced and/or weighted by its own derivative in some embodiments), a softmax function such as

$$f ( {x}_{i} ) = \frac{{e}^{x}}{{\sum }_{i} {x}_{i}}$$

where the inputs to an instant layer are xᵢ, a swish function such as ƒ(x)=x*sigmoid(x), a Gaussian error linear unit function such as f(x)=a(1+tan h(\sqrt{2/π}(x+bx^{r}))) for some values of a, b, and r, and/or a scaled exponential linear unit function such as

$$f ( x ) = λ \{ \begin{matrix}α ( {e}^{x} - 1 ) for x < 0 \\ x for x \geq 0\end{matrix} .$$

Fundamentally, there is no limit to the nature of functions of inputs xᵢ that may be used as activation functions. As a non-limiting and illustrative example, node may perform a weighted sum of inputs using weights wᵢ that are multiplied by respective inputs xᵢ. Additionally or alternatively, a bias b may be added to the weighted sum of the inputs such that an offset is added to each unit in the neural network layer that is independent of the input to the layer. The weighted sum may then be input into a function φ, which may generate one or more outputs y. Weight wᵢ applied to an input xᵢ may indicate whether the input is “excitatory,” indicating that it has strong influence on the one or more outputs y, for instance by the corresponding weight having a large numerical value, and/or a “inhibitory,” indicating it has a weak effect influence on the one more inputs y, for instance by the corresponding weight having a small numerical value. The values of weights wᵢ may be determined by training a neural network using training data, which may be performed using any suitable process as described above.

Still referring to FIG. 14, a “convolutional neural network,” as used in this disclosure, is a neural network in which at least one hidden layer is a convolutional layer that convolves inputs to that layer with a subset of inputs known as a “kernel,” along with one or more additional layers such as pooling layers, fully connected layers, and the like. CNN may include, without limitation, a deep neural network (DNN) extension, where a DNN is defined as a neural network with two or more hidden layers.

Still referring to FIG. 14, in some embodiments, a convolutional neural network may learn from images. In non-limiting examples, a convolutional neural network may perform tasks such as classifying images, detecting objects depicted in an image, segmenting an image, and/or processing an image. In some embodiments, a convolutional neural network may operate such that each node in an input layer is only connected to a region of nodes in a hidden layer. In some embodiments, the regions in aggregate may create a feature map from an input layer to the hidden layer. In some embodiments, a convolutional neural network may include a layer in which the weights and biases for all nodes are the same. In some embodiments, this may allow a convolutional neural network to detect a feature, such as an edge, across different locations in an image.

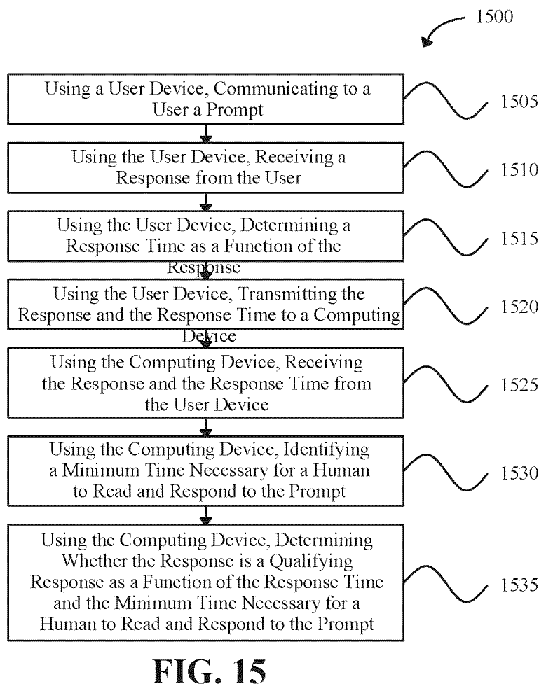

Referring now to FIG. 15, an exemplary embodiment of a method 1500 of gathering qualifying responses is illustrated. One or more steps if method 1500 may be implemented, without limitation, as described with reference to other figures. One or more steps of method 1500 may be implemented, without limitation, using at least a processor.

Still referring to FIG. 15, in some embodiments, method 1500 may include a step 1505 of using a user device, communicating to a user a prompt.

Still referring to FIG. 15, in some embodiments, method 1500 may include a step 1510 of using the user device, receiving a response from the user.

Still referring to FIG. 15, in some embodiments, method 1500 may include a step 1515 of using the user device, determining a response time as a function of the response.

Still referring to FIG. 15, in some embodiments, method 1500 may include a step 1520 of using the user device, transmitting the response and the response time to a computing device.

Still referring to FIG. 15, in some embodiments, method 1500 may include a step 1525 of using the computing device, receiving the response and the response time from the user device.

Still referring to FIG. 15, in some embodiments, method 1500 may include a step 1530 of using the computing device, identifying a minimum time necessary for a human to read and respond to the prompt.

Still referring to FIG. 15, in some embodiments, method 1500 may include a step 1535 of using the computing device, determining whether the response is a qualifying response as a function of the response time and the minimum time necessary for a human to read and respond to the prompt. In some embodiments, a response is determined not to be a qualifying response if the response time is less than the minimum time necessary for a human to read and respond to the prompt.

Still referring to FIG. 15, in some embodiments, method 1500 may further include steps of using an audiovisual sensor of the user device, collecting audiovisual data, using the user device, transmitting the audiovisual data to the computing device, using the computing device, receiving the audiovisual data from the user device, and using the computing device, determining an emotional state of the user as a function of the audiovisual data.

Still referring to FIG. 15, in some embodiments, method 1500 may further include steps of, using the user device, collecting audiovisual data using an audiovisual sensor, transmitting the audiovisual data to the computing device, and using the computing device, receiving the audiovisual data from the user device, and determining an emotional state of the user as a function of the audiovisual data. In some embodiments, the prompt is directed to an emotion of the user, and determining the emotional state of the user includes determining the emotional state as a function of the response and the determination as to whether the response is a qualifying response. In some embodiments, the audiovisual data comprises audio data, and determining the emotional state of the user further comprises generating a transcript by transcribing the audio data using an automatic speech recognition system. In some embodiments, determining the emotional state of the user further comprises processing the transcript using a sentiment analysis process. In some embodiments, the audiovisual data comprises natural language data, and determining the emotional state of the user further comprises interpreting the natural language data using a large language model. In some embodiments, the audiovisual data comprises video data, and determining the emotional state of the user further comprises processing the video data using a machine vision system. In some embodiments, the method further comprises using the computing device, transmitting to the user device the emotional state of the user, and using the user device, configuring a digital avatar as a function of the emotional state, and displaying to the user the configured digital avatar.

Still referring to FIG. 15, in some embodiments, method 1500 may further include a step of, using the user device, communicating to the user a plurality of prompts, receiving a plurality of responses from the user, determining a plurality of response times, and transmitting the plurality of responses and the plurality of response times to the computing device, using the computing device, receiving the plurality of responses and the plurality of response times from the user device and determining whether a response of the plurality of responses is a qualifying response as a function of each response time of the plurality of response times.

Still referring to FIG. 15, in some embodiments, method 1500 may further include a step of, using the computing device, determining whether the response is a qualifying response as a function of the response time and a maximum time.

Still referring to FIG. 15, in some embodiments, method 1500 may further include a step of, using the computing device, determining a performance metric as a function of a qualifying response.

The corresponding structures, materials, acts, and equivalents of all means or step plus function elements in the claims below are intended to include any structure, material, or act for performing the function in combination with other claimed elements as specifically claimed. The description of the present disclosure has been presented for purposes of illustration and description but is not intended to be exhaustive or limited to the present disclosure in the form disclosed. Many modifications and variations will be apparent to those of ordinary skill in the art without departing from the scope and spirit of the present disclosure. Exemplary embodiments were chosen and described in order to best explain the principles of the present disclosure and its practical application, and to enable others of ordinary skill in the art to understand the present disclosure for various embodiments with various modifications as are suited to the particular use contemplated.

While various embodiments have been described above, it should be understood that they have been presented by way of example only, and not limitation. The descriptions are not intended to limit the scope of the invention to the particular forms set forth herein. To the contrary, the present descriptions are intended to cover such alternatives, modifications, and equivalents as may be included within the spirit and scope of the invention as defined by the appended claims and otherwise appreciated by one of ordinary skill in the art. Thus, the breadth and scope of a preferred embodiment should not be limited by any of the above-described exemplary embodiments.

What is claimed is:

1. A system for gathering qualifying responses, the system comprising:
a user device configured to:
communicate to a user a prompt;
receive a response from the user;
determine a response time as a function of the response; and
transmit the response and the response time to a computing device; and
the computing device configured to:
receive the response and the response time from the user device;
identify a minimum time necessary for a human to read and respond to the prompt; and
determine whether the response is a qualifying response as a function of the response time and the minimum time necessary for a human to read and respond to the prompt.

2. The system of claim 1, wherein:
the user device comprises an audiovisual sensor;
the user device is further configured to:
collect audiovisual data using the audiovisual sensor; and
transmit the audiovisual data to the computing device; and
the computing device is further configured to:
receive the audiovisual data from the user device; and
determine an emotional state of the user as a function of the audiovisual data.

3. The system of claim 2, wherein:
the prompt is directed to an emotion of the user; and
determining the emotional state of the user comprises determining the emotional state as a function of the response and the determination as to whether the response is a qualifying response.

4. The system of claim 2, wherein:
the audiovisual data comprises audio data; and
determining the emotional state of the user further comprises generating a transcript by transcribing the audio data using an automatic speech recognition system.

5. The system of claim 4, wherein determining the emotional state of the user further comprises processing the transcript using a sentiment analysis process.

6. The system of claim 2, wherein:
the audiovisual data comprises natural language data; and
determining the emotional state of the user further comprises interpreting the natural language data using a large language model.

7. The system of claim 2, wherein:
the audiovisual data comprises video data; and
determining the emotional state of the user further comprises processing the video data using a machine vision system.

8. The system of claim 2, wherein:
the computing device is further configured to transmit to the user device the emotional state of the user; and
the user device is further configured to:
configure a digital avatar as a function of the emotional state; and
display to the user the configured digital avatar.

9. The system of claim 1, wherein the computing device is further configured to determine whether the response is a qualifying response as a function of the response time and a maximum time.

10. The system of claim 1, wherein the computing device is further configured to determine a performance metric as a function of the qualifying response.

11. The system of claim 1, wherein determining whether the response is a qualifying response comprises:
determining whether the response is an emotional response or an intellectual response; and
determining the response to be a qualifying response if the response is an intellectual response.

12. A method of gathering qualifying responses, the method comprising:
using a user device, communicating to a user a prompt;
using the user device, receiving a response from the user;
using the user device, determining a response time as a function of the response;
using the user device, transmitting the response and the response time to a computing device;
using a computing device, receiving the response and the response time from the user device;
using the computing device, identifying a minimum time necessary for a human to read and respond to the prompt; and
using the computing device, determining whether the response is a qualifying response as a function of the response time and the minimum time necessary for a human to read and respond to the prompt.

13. The method of claim 12, wherein the method further comprises:
using an audiovisual sensor of the user device, collecting audiovisual data;
using the user device, transmitting the audiovisual data to the computing device;
using the computing device, receiving the audiovisual data from the user device; and
using the computing device, determining an emotional state of the user as a function of the audiovisual data.

14. The method of claim 13, wherein:
the prompt is directed to an emotion of the user; and
determining the emotional state of the user comprises determining the emotional state as a function of the response and the determination as to whether the response is a qualifying response.

15. The method of claim 13, wherein:
the audiovisual data comprises audio data; and
determining the emotional state of the user further comprises generating a transcript by transcribing the audio data using an automatic speech recognition system.

16. The method of claim 15, wherein determining the emotional state of the user further comprises processing the transcript using a sentiment analysis process.

17. The method of claim 13, wherein:
the audiovisual data comprises natural language data; and
determining the emotional state of the user further comprises interpreting the natural language data using a large language model.

18. The method of claim 13, wherein:
the audiovisual data comprises video data; and
determining the emotional state of the user further comprises processing the video data using a machine vision system.

19. The method of claim 13, wherein the method further comprises:
using the computing device, transmitting to the user device the emotional state of the user; and
using the user device, configuring a digital avatar as a function of the emotional state; and
using the user device, displaying to the user the configured digital avatar.

20. The method of claim 13, wherein the method further comprises, using the computing device, determining whether the response is a qualifying response as a function of the response time and a maximum time.

21. The method of claim 13, wherein the method further comprises, using the computing device, determining a performance metric as a function of the qualifying response.

22. The method of claim 12, wherein determining whether the response is a qualifying response comprises:
determining whether the response is an emotional response or an intellectual response; and
determining the response to be a qualifying response if the response is an intellectual response.
